(19) United States
(12) Patent Application Publication
(10) Pub. No.: US 2011/0234679 A1
(43) Pub. Date: Sep. 29, 2011

(54) INK SET FOR INK JET AND IMAGE FORMING METHOD

(75) Inventor: Ryo SAITO, Kanagawa (JP)

(73) Assignee: FUJIFILM CORPORATION, Tokyo (JP)

(21) Appl. No.: 13/043,490

(22) Filed: Mar. 9, 2011

(30) Foreign Application Priority Data
Mar. 26, 2010 (JP) 2010-073009

(51) Int. Cl. B41J 2/015; C09D 11/10; C08K 5/42; C08K 3/32; C08K 5/092; C08K 5/17

(52) U.S. Cl. 347/20; 524/500; 524/157; 524/417; 524/320; 524/186

(57) ABSTRACT

The present invention provides an ink set for ink jet containing a fixing agent liquid including an acidic precipitant and a cationic polymer that is a copolymer of epihalohydrin and amine; and an ink including a self-dispersing pigment and a first anionic polymer in an aqueous medium wherein the first anionic polymer is insoluble in the aqueous medium, and a method of forming an image using the ink set for ink jet.

### CROSS-REFERENCE TO RELATED APPLICATION

This application claims priority under 35 USC 119 from Japanese Patent Application No. 2010-073009 filed on Mar. 26, 2010, the disclosure of which is incorporated by reference herein.

### BACKGROUND OF THE INVENTION

1. Field of the Invention

The present invention relates to an ink set for ink jet and an image forming method.

2. Description of the Related Art

An ink jet recording method is a method for recording an image by ejecting an ink in the form of liquid droplets from plural nozzles provided in an ink jet head, toward an recording medium and fixing the ink on the recording medium. In order to obtain a high-resolution image with good qualities, a fixing agent liquid (also called “fixing liquid”, “treatment liquid” or “reaction liquid”) containing a compound facilitating aggregation of an ink as a technique for rapidly fixing an ink on a recording medium has been researched.

In this regard, an image printing method using an ink jet ink composition containing a coloring agent and a first liquid vehicle, a fixing agent containing a second liquid vehicle and from 0.5 to 5% by mass of a cationic copolymer of epihalohydrin and amine is disclosed and it is said that images with durability can be formed (for example, see Japanese Patent Application National phase Publication (JP-T) No. 2009-509822).

In addition, an ink jet printing system using a fixing agent liquid containing a cationic polymer and an acidic precipitant, and an ink jet ink containing a pigment to which an anionic polymer is covalently bonded and one of a nonionic surfactant or an anionic binder is disclosed, and it is said that mottle (uneven print density) during printing can be improved (reduced) (for example, Japanese Patent No. 4224491 and Japanese Patent Application Laid-open (JP-A) No. 2006-159907).

However, the systems disclosed in JP-T No. 2009-509822, Japanese Patent No. 4224491 and JP-A No. 2006-159907 are insufficient in terms of continuous ejectability and ejection stability (recovery properties of nozzles left as it is). These problems are particularly significant when a piezo method is used as an ink jet method.

### SUMMARY OF THE INVENTION

According to a first aspect of the present invention, there is provided an ink set for ink jet containing a fixing agent liquid including an acidic precipitant and a cationic polymer that is a copolymer of epihalohydrin and amine; and an ink including a self-dispersing pigment and a first anionic polymer in an aqueous medium wherein the first anionic polymer is insoluble in the aqueous medium.

### DETAILED DESCRIPTION OF THE INVENTION

### Ink Set for Ink Jet

The ink set for an ink jet of the present invention has a configuration that is composed of a fixing agent liquid including an acidic precipitant and a cationic polymer that is a copolymer of epihalohydrin and amine; and an ink including a self-dispersing pigment and a first anionic polymer in an aqueous medium wherein the first anionic polymer is insoluble in the aqueous medium.

Based on this configuration, the ink set for ink jet of the present invention exhibits superior continuous ejection. In addition, the ink set exhibits superior ejection stability and thus excellent recovery properties of the nozzle left as it is.

Images formed using the ink set for ink jet of the present invention exhibit improved rub (scratch or abrasion) resistance (hereinafter, may be referred to as rub resistance), favorable qualities and favorable color density.

The ink set for ink jet of the present invention is favorable for forming images by inkjetting, and in particular, is preferred as an ink set used for the image forming method of the present invention as described below.

The ink set for ink jet of the present invention may provided in the form of an ink cartridge in which an ink and a fixing agent liquid are independently or integrally packed and the use as an ink cartridge is preferred from the viewpoints of easy handling. The ink cartridge including the ink set is known in the art, and can be made by using appropriately a known method.

Fixing Agent Liquid

The fixing agent liquid used in the present invention may be composed of at least one acidic precipitant and at least one cationic polymer that is a copolymer of epihalohydrin and amine, and optionally an additional component. The fixing agent liquid comes in contact with the ink of the present invention (also referred to as “the ink composition”), thereby promoting aggregation of components contained in the ink.

Cationic Polymer that is a Copolymer of Epihalohydrin and Amine

A cationic polymer that is a copolymer of epihalohydrin and amine (hereinafter, also referred to simply as “a cationic copolymer”) in the fixing agent liquid reacts with anionic components that are stably dispersed or dissolved in an ink, thereby promoting aggregation of the anionic components and fixing the ink on a recording medium.

The copolymer of epihalohydrin and amine, when used in the fixing agent liquid, exhibits superior ink aggregability, as compared to other cationic copolymers such as poly(hexamethylene ganidine), poly(diallyldimethylammonium chloride) or polyvinyl amine). As a result, favorable rub resistance and favorable color density of the formed image are achieved and spotting interference is suppressed.

The amine used for preparing the cationic copolymer is preferably primary or secondary amine. The secondary amine is useful for the preparation of linear copolymers. The primary amine may impart branches to the copolymer.

In the present invention, both primary amine and the secondary amine may be used together for the preparation of the cationic copolymer. In this case, a mix ratio (molar ratio) of the primary amine and the secondary amine may be about 100/1 to 10/1, and the desired ratio of branches may be imparted to the copolymer depending on the mix ratio.

Examples of the primary amine used for preparing the cationic copolymer include amines containing one hydrocarbon group such as an alkyl group, a cycloalkyl group, an aryl group, a heteroaryl group or an aralkyl group. Similarly, examples of the secondary amine include amines containing two hydrocarbon groups which are the same or different, such as an alkyl group, a cycloalkyl group, an aryl group, a heteroaryl group or an aralkyl group.

The alkyl group preferably has from 1 to 12 carbon atoms, and more preferably from 1 to 4 carbon atoms. Specific examples of the alkyl group include a methyl group, an ethyl group, a propyl group and an isopropyl group. The cycloalkyl group preferably has from 5 to 12 carbon atoms, and more preferably from 5 to 8 carbon atoms. Specific examples of the cycloalkyl group include a cyclohexyl group and a cyclooctyl group. The aryl group preferably has from 6 to 14 carbon atoms, and more preferably from 6 to 10 carbon atoms. Specific examples of the aryl group include a phenyl group, a tolyl group, a naphthyl group and an anisyl group.

The heteroaryl group preferably has from 5 to 13 ring-constituting atoms, and more preferably from 5 to 9 ring-constituting atoms. In addition, heteroatoms as the ring-constituting atom include, for example, oxygen, sulfur and nitrogen. Specific examples of the heteroaryl group include a thienyl group, a furyl group and a pyrrolyl group. The aralkyl group preferably has from 7 to 15 carbon atoms, and more preferably from 7 to 11 carbon atoms. Specific examples of the aralkyl group include a benzyl group, a phenethyl group and a naphthylmethyl group.

Examples of the primary amine favorably used for the preparation of the cationic copolymer include methyl amine, ethylamine, propyl amine, butyl amine, cyclohexyl amine and benzyl amine. Similarly, examples of the secondary amine include dimethylamine, diethylamine, dipropylamine, dibutylamine and dicyclohexylamine.

A mix ratio of epihalohydrin and amine used for the preparation of the cationic copolymer is preferably in the range of from 0.5 parts by mole to 2 parts by mole of the epihalohydrin with respect to 1 part by mole of amino group contained in the amine, more preferably from 0.6 parts by mole to 1.8 parts by mole, and still more preferably from 0.8 to 1.5 parts by mole. When the addition amount of epihalohydrin is 0.5 parts by mole or higher, stable reactants are easy to be obtained, and when the addition amount of epihalohydrin is 2 parts by mole or less, superior rub resistance and superior water resistance can be achieved by the fixing agent liquid prepared therefrom.

A molecular weight of the cationic copolymer is preferably a molecular weight which gives the viscosity of the viscosity of from 5 cp to 10,000 cp at ambient temperature (25° C.) in terms of a 50% aqueous solution (50% by mass of water and 50% by mass of a copolymer), from the viewpoints of applicability of fixing agent liquid to the recording medium and aggregation speed of the ink composition. The molecular weight which gives the viscosity of from 10 cp to 100 cp at ambient temperature is more preferred. This definition associated with viscosity is used because it is difficult to determine an actual molecular weight of this type of polymer.

A content of the cationic copolymer in the fixing agent liquid is preferably in the range of from 0.1% by mass to 30% by mass, more preferably from 0.5% by mass to 20% by mass, still more preferably from 1% by mass to 20% by mass, and still more preferably from 1% by mass to 5% by mass with respect to a total amount of the fixing agent liquid, from the viewpoints of ink aggregation effects.

The fixing agent liquid of the present invention may contain other cationic component (s) in addition to the cationic copolymer (also referred to as “a second cationic component”). Examples of the other cationic component include a multivalent salt and other cation polymer or copolymer. From the viewpoint of improvement in the aggregation speed of ink composition and rub resistance of the image, the fixing agent liquid of the present invention preferably contains, in addition to the cationic copolymer, at least one second cationic component selected from polyvalent metal nitrates, EDTA (ethylenediaminetetraacetic acid) salts, and phosphonic acid-based chelating agents or salts thereof. The polyvalent metal nitrate, the EDTA salt and the phosphonium halide may be individually used alone, or may be used in combination thereof.

From the viewpoints of improving high-speed aggregability and rub resistance of images, examples of preferred polyvalent metal nitrates include salts of alkaline earth metals of Group II of the periodic table (for example, magnesium or calcium), salts of transition metals of Group III of the periodic table (for example, lanthanum), salts of cations derived from metals of Group XIII of the periodic table (for example, aluminum), and salts of lanthanide (for example, neodymium). Of these, calcium nitrate or magnesium nitrate is preferable.

From the viewpoints of improving high speed aggregability and rubresistance of the image, among the EDTA salts, for examples, sodium EDTA salts such as EDTA-2Na, EDTA-3Na or EDTA-4Na may be preferably used.

Examples of the phosphonic acid-based chelating agents or salts thereof include amino tri(methylenephosphonic acid), 1-hydroxyethane-1,1-diphosphonic acid, ethylenediaminetetra(methylenephosphonic acid), hexamethylenediaminetetra(methylenephosphonic acid), diethylenetriaminepenta(methylenephosphonic acid) and salts thereof.

The phosphonic acid-based chelate agents or salts thereof are available from commercial products and examples thereof include DQ2000 [aminotri(methylenephosphonic acid)], DQ2006 [aminotri(methylenephosphonic acid).5Na salts], DQ2010 [1-hydroxyethane-1,1-diphosphonic acid], DQ2016 [1-hydroxyethane-1,1-diphosphonic acid.4Na salts], DQ2041 [ethylenediaminetetra(methylenephosphonic acid)], DQ2042[ethylenediaminetetra(methylenephosphonic acid).5NH₄ salts], DQ2044[ethylenediaminetetra(methylenephosphonic acid).5K salts], DQ2051[hexamethylenediaminetetra(methylenephosphonic acid)], DQ2052[hexamethylenediaminetetra(methylenephosphonic acid).6NH₄ salts], DQ2054[hexamethylenediaminetetra(methylenephosphonic acid).6K salts], DQ2060[diethylenetriaminepenta(methylenephosphonic acid)], DQ2066[diethylenetriaminepenta(methylenephosphonic acid).5Na salts]. All of these products may be used and they are all products of Monsanto Japan Limited.

From the viewpoint of the aggregation speed of ink composition, a content of the second cationic component is preferably from 0.1% by mass to 15% by mass, more preferably from 0.1% by mass to 10% by mass, and still more preferably 0 from 1% by mass to 5% by mass, with respect to a total amount of the fixing agent liquid.

A content ratio of cationic copolymer to second cationic component in the fixing agent liquid (second cationic component:cationic copolymer [mass ratio]) is preferably from 1:5 to 1:40, more preferably 1:10 to 1:30, and still more preferably from 1:15 to 1:25 from the viewpoint of the aggregation speed of ink composition.

Acidic Precipitant

The acidic precipitant may be at least one of organic acids, inorganic acids and derivatives thereof (including optical isomers) or salts thereof (for example, polyvalent metal salts). The compound may be used alone or in combination of two or more types thereof. The acidic precipitant comes in contact with the ink composition to produce an aggregator.

The organic acid and inorganic acid that are useful as the acidic precipitant are not limited, and examples thereof include compounds having a phosphoric acid group, a phosphonic acid group, a phosphine acid group, a sulfuric acid group, a sulfone acid group, a sulfinic acid group, a thiocyanic acid group or a carboxyl group, or salts thereof (for example, polyvalent metal salts). Of these, from the viewpoints of aggregation speed of the ink composition, compounds having a phosphoric acid group or a carboxyl group are preferred and compounds having a carboxyl group are more preferred.

Specific examples of the acidic precipitant are preferably selected from polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, methanesulfonic acid, phosphoric acid, metaphosphoric acid, orthophosphoric acid, pyrrolidone carboxylic acid, pyrone carboxylic acid, pyrrole carboxylic acid, furan carboxylic acid, pyridine carboxylic acid, coumaric acid, thiophene carboxylic acid, nicotinic acid, thiocyanic acid, or derivatives of these compounds (including optical isomers), or salts thereof (such as polyvalent metal salts). These compounds may be used alone or in combination of two or more thereof.

From the viewpoints of high speed aggregability, examples of the polyvalent metal salt include salts of alkaline earth metals (for example, magnesium or calcium) of Group II of the periodic table, salts of transition metals (for example, lanthanum) of Group III of the periodic table, salts of cations (for example, aluminum) derived from metals of Group XIII of the periodic table, and salts of lanthanide (for example, neodymium). Examples of favorable metal salts include metal carboxylates (formates or benzoates), metal chlorides, and metal thiocyanates. Of these, calcium or magnesium carboxylates (such as calcium formate, calcium benzoate, magnesium formate or magnesium benzoate), calcium chloride, magnesium chloride, and calcium thiocyanate or magnesium thiocyanate are preferred.

From the viewpoint of improving aggregation speed of the ink composition and the viewpoint of water resistance of the image, the acidic precipitant of the present invention is preferably at least one selected from methanesulfonic acid, citric acid, succinic acid, phosphoric acid, glycolic acid, acetic acid, tartaric acid, oxalic acid or derivatives, or salts thereof.

A content of acidic precipitant in the fixing agent liquid is preferably an amount necessary to produce a quaternized cationic polymer. In addition, from the viewpoints of further improvement of aggregation effect, the content of acidic precipitant is preferably from 5% by mass to 30% by mass, more preferably from 10% by mass to 30% by mass, and still more preferably from 10% by mass to 27% by mass, with respect to t a total amount of the fixing agent liquid.

By controlling the content of acidic precipitant in the fixing agent liquid within the range, a superior aggregation effect can be achieved, and resultantly a bleeding-free-high-definition drawn image in which a dot diameter is controlled may be obtained.

Organic Solvent

The fixing agent liquid of the present invention preferably contains at least one organic solvent. The organic solvent is more preferably a hydrophilic organic solvent. In a case in which the fixing agent liquid contains an organic solvent (in particular, a hydrophilic organic solvent), surface tension can be controlled or anti-drying, or permeation promotion can be realized.

Specific examples of the hydrophilic organic solvent are the same as those of hydrophilic organic solvent in the ink described below. The organic solvent may be used alone or as a mixture of two or more kinds thereof.

A content of the organic solvent in the fixing agent liquid is not particularly limited and is preferably from 1% by mass to 30% by mass, and more preferably from 5% by mass to 15% by mass from the viewpoints of control of surface tension, anti-drying and permeation promotion, and inhibition of reaction of the acidic precipitant with the composition in the recording medium.

Surfactant

The fixing agent liquid of the present invention may contain at least one surfactant. The surfactant is used as a surface tension adjuster. Examples of the surface tension adjuster include nonionic surfactants, cationic surfactants, anionic surfactants and betaine surfactants.

Specific examples of the surfactant are the same as those of hydrophilic organic solvent in the ink described below. The surfactant may be used alone or as a mixture of two or more kinds thereof.

Water

The fixing agent liquid of the present invention preferably contains water. A content of water is not particularly limited and is preferably from 10% by mass to 99% by mass, more preferably from 30% by mass to 80% by mass, and still more preferably from 50% by mass to 70% by mass.

Other Additives

The fixing agent liquid of the present invention may contain other additives, in addition to the above components. Examples of other additives include known additives such as discolorization inhibitors, emulsion stabilizers, permeation accelerators, UV absorbers, preservatives, mold-inhibiting agents, pH adjusters, defoaming agents, viscosity adjusters, rust inhibitors and chelating agents. These various additives may be directly added after or during the preparation.

Physical Properties of Fixing Agent Liquid

From the viewpoints of aggregation speed of the ink, a pH (25° C.) of the fixing agent liquid is preferably 3.5 or less, more preferably from 0.5 to 2.5, still more preferably from 0.7 to 2.3, and still more preferably from 0.8 to 2.0. In this case, a pH (25° C.) of the ink is preferably 7.0 or higher, and more preferably from 7 to 10.

Of these, from the viewpoints of image density, resolution and realization of high-speed of ink jet recording, it is preferable that the pH (25° C.) of ink is 7.0 or higher and the pH (25° C.) of the fixing agent liquid is 3.5 or less.

From the viewpoints of aggregation speed of ink, a viscosity of fixing agent liquid is preferably from 1 mPa·s to 30 mPa·s, more preferably from 1 mPa·s to 20 mPa·s, still more preferably from 2 mPa·s to 15 mPa·s, and still more preferably from 2 mPa·s to 10 mPa·s. In addition, the viscosity is measured under conditions of 20° C. using VISCOMETER TV-22 (trade name, manufactured by Toki Sangyo Co., Ltd.).

From the viewpoints of aggregation speed of the ink composition, a surface tension of the fixing agent liquid is preferably from 20 mN/m to 60 mN/m, more preferably from 20 mN/m to 45 mN/m, and still more preferably 25 mN/m to 40 mN/m. The surface tension is measured under conditions of 25° C. using an Automatic Surface Tensiometer CBVP-Z (trade name, manufactured by Kyowa Interface Science Co., Ltd.).

Ink

The ink used in the present invention (also referred to as “an ink composition”) contains, in an aqueous medium, at least one self-dispersing pigment and at least one first anionic polymer and optionally contains other components. The first anionic polymer contained in the ink used in the present invention is insoluble in the ink-constituting aqueous medium.

The ink used in the present invention exhibits reduced foam generation and at the same time has a superior defoaming property.

Aqueous Medium

The term “aqueous medium” herein used refers to a liquid in which the self-dispersing pigment and the first anionic polymer are contained to form an ink.

The aqueous medium of the present invention contains water as a solvent. A content of water is preferably from 10% by mass to 99% by mass, more preferably from 30% by mass to 80% by mass, and still more preferably from 50% by mass to 70% by mass with respect to a total amount of the ink.

The aqueous medium used in the present invention preferably contain at least one hydrophilic organic solvent. The hydrophilic organic solvent can be contained for anti-drying, or permeation acceleration of an ink. Specifically, for example, in the case where the hydrophilic organic solvent is added as an anti-drying agent, clogging of ink jet nozzles caused by drying of the ink jet ink at the nozzle injection ports can be effectively prevented. In addition, the hydrophilic organic solvent may be added alone or as a mixture of two or more kinds thereof.

A hydrophilic organic solvent having a vapor pressure lower than water is preferred in terms of anti-drying. Specific examples of the hydrophilic organic solvent favorable for anti-drying include polyhydric alcohols such as ethyleneglycol, propyleneglycol, diethyleneglycol, polyethylene glycol, thiodiglycol, dithiodiglycol, 2-methyl-1,3-propanediol, 1,2,6-hexanetriol, acetyleneglycol derivatives, glycerin, or trimethylolpropane; lower alkylethers of polyhydric alcohols such as ethylene glycol monomethyl (or ethyl)ether, diethylene glycol monomethyl (or ethyl)ether, triethylene glycol monoethyl (or butyl)ether; heterocycles such as 2-pyrrolidone, N-methyl-2-pyrrolidone, 1,3-dimethyl-2-imidazolidinone, or N-ethyl morpholine; sulfur-containing compounds such as sulfolane, dimethylsulfoxide or 3-sulfolene; polyfunctional compounds such as diacetone alcohol or diethanol amine; and urea derivatives.

Of these, the hydrophilic organic solvent is preferably polyhydric alcohol such as glycerin or diethylene glycol. The hydrophilic organic solvent may be used alone or in a combination of two or more kinds thereof. A content of hydrophilic organic solvent is preferably from 10% by mass to 50% by mass in the ink composition.

In addition, a hydrophilic organic solvent is favorable for use in promoting the penetration of the ink composition into a recording medium. Specific examples of the hydrophilic organic solvent suitable for permeation acceleration include alcohols such as ethanol, iso-propanol, butanol, di(tri)ethyleneglycolmonobutylether or 1,2-hexanediol. The hydrophilic organic solvent is contained in an amount of from 5% by mass to 30% by mass in the ink composition, thereby exhibiting superior effects. In addition, the hydrophilic organic solvent is preferably used within an addition amount range such that bleeding of print or image and print-through do not occur.

Further, the hydrophilic organic solvent is used for controlling viscosity in addition to the above. Specific examples of the hydrophilic organic solvent which can be used for controlling viscosity include alcohols (for example, methanol, ethanol, propanol, isopropanol, butanol, isobutanol, sec-butanol, t-butanol, pentanol, hexanol, cyclohexanol, benzyl alcohol), polyhydric alcohols (for example, ethylene glycol, diethylene glycol, triethylene glycol, tetraethylene glycol, polyethylene glycol, propylene glycol, dipropylene glycol, tripropylene glycol, polypropylene glycol, butylene glycol, trimethylolpropane, hexanediol, pentanediol, glycerin, hexanetriol, thiodiglycol), glycol derivatives (for example, ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, ethylene glycol monophenyl ether), amines (for example, ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethylenimine, tetramethylpropylenediamine), and additive polar solvents (for example, formamide, N,N-dimethylformamide, N,N-dimethylacetamide, dimethylsulfoxide, sulfolane, 2-pyrrolidone, N-methyl-2-pyrrolidone, N-vinyl-2-pyrrolidone, 2-oxazolidine, 1,3-dimethyl-2-imidazolidinone, acetonitrile or acetone).

A content of hydrophilic organic solvent in the aqueous medium is preferably 50% by mass or less, more preferably from 5% by mass to 30% by mass, and still more preferably from 10% by mass to 25% by mass with respect to the amount of water.

First Anionic Polymer

A first anionic polymer is insoluble in the aqueous medium with which the ink is constituted.

The term “insoluble” herein used means that in the case where a polymer is mixed with an aqueous medium at 25° C. to prepare a mixture having the polymer content of 8% by mass, the amount of the polymer dissolved in the aqueous medium is 10% by mass or less with respect to the amount of the polymer mixed with the aqueous medium.

From the viewpoints of improvement of continuous ejection and ejection stability of ink, the mass ratio of the first anionic polymer used in the present invention is preferably as low as possible, more preferably 5% by mass or less, and still more preferably 0% by mass.

The first anionic polymer aggregates, when it comes in contact with the above fixing agent liquid or a dried region of the fixing agent liquid, and thickens the ink and fixes the ink composition and thereby further improves fixability of ink composition to the recording medium and rub resistance of the image.

Examples of the first anionic polymer include resin particles containing an anionic group. Examples of the resin include thermoplastic, thermocurable or modified acrylic, epoxy, polyurethane, polyether, polyamide, unsaturated polyester, phenol, silicone or fluorine resins; polyvinyl resins such as polyvinyl chloride, polyvinyl acetate, polyvinyl alcohol and polyvinyl butyral; polyester resins such as alkyd resins and phthalic acid resins; and amino substances such as melamine resins, melamine formaldehyde resins, amino alkyd co-condensed resins, urea resins and copolymers or mixtures thereof. Of these, the anionic acryl resins may be obtained by polymerizing acrylic monomers having an anionic group (anionic group-containing acrylic monomers) and optionally other monomers copolymerizable with the anionic group-containing acrylic monomers in a solvent. Examples of the anionic group-containing acrylic monomer include acrylic monomers containing at least one anionic group selected from the group consisting of a carboxyl group, a sulfonic acid group and a phosphonic group. Of these, acrylic monomers having a carboxyl group (such as, acrylic acid, methacrylic acid, crotonic acid, ethaacrylic acid, propylacrylic acid, isopropylacrylic acid, itaconic acid and fumaric acid) are preferred, and acrylic acid or methacrylic acid is particularly preferred.

The first anionic polymer may be used alone or in combination of two or more thereof.

Self-dispersing polymer particles are preferable as the first anionic polymer from the viewpoints of ejection stability (discharge stability) and liquid stability (in particular, dispersion stability) of pigment-containing system.

The term “self-dispersing polymer particle” refers to a water-insoluble polymer particle that, in the absence of other surfactants, can be dispersed in an aqueous medium by a functional group contained in the polymer (in particular, an acidic group or a salt thereof) and that contains no free emulsifying agent. The aqueous medium contains water as components and may optionally contain a hydrophilic organic solvent. The aqueous medium preferably contains, as components, water and 0.2% by mass or less of a hydrophilic organic solvent with respect to the amount of water and more preferably contains only water as the aqueous medium.

The “dispersion state” can be either an emulsion state, in which the water-insoluble polymer is dispersed as a liquid in an aqueous medium, or a suspension state, in which the water-insoluble polymer is dispersed as a solid in an aqueous medium.

From the viewpoint of the aggregation rate and the fixing property when the water-insoluble polymer is employed to form the ink composition, the water-insoluble polymer used in the invention is preferably one that can be in the suspension state, in which the water-insoluble polymer is dispersed as a solid in an aqueous medium.

The “dispersion state” of the self-dispersible polymer particles used in the invention refers to a state in which a self-dispersible polymer particles can be visually confirmed as being in a stable dispersion state at 25° C. over at least one week, even after the self-dispersible polymer particle dispersion has been prepared by mixing and stirring, by using a stirrer having a stirring blade with number of rotations of 200 rpm for 30 minutes at 25° C., a mixture solution of a solution containing 30 g of the water-insoluble polymer dissolved in 70 g of organic solvent such as methyl ethyl ketone, a neutralizer which can neutralize all salt-forming groups of the water-insoluble polymer, and 200 g of water, and then removing the organic solvent from the mixture solution, wherein the neutralizer is either sodium hydroxide when the salt-forming group is anionic, or acetic acid when the salt-forming group is cationic.

The “water-insoluble polymer” refers to a polymer whose dissolved amount to 100 g of water at 25° C. is 10 g or lower when the polymer is dried at 105° C. for 2 hours and then dissolved in the water. The dissolved amount is preferably 5 g or lower, and more preferably 1 g or lower. The “dissolved amount” is an amount of (a part of) the water-insoluble polymer dissolved in a solvent (water) when the water-insoluble polymer is completely neutralized with sodium hydroxide or acetic acid, wherein the selection from the sodium hydroxide and the acetic acid accords to the type of the salt-forming group of the water-insoluble polymer.

There is no limitation on the main chain skeleton of the water-insoluble polymer. Examples of the polymer include a vinyl polymer and a condensed polymer (e.g., an epoxy resin, polyester, polyurethane, polyamide, cellulose, polyether, polyurea, polyimide, and polycarbonate). Among the above, a vinyl polymer is particularly preferable.

Preferable examples of a vinyl polymer and a monomer which configures the vinyl polymer include substances disclosed in JP-A Nos. 2001-181549 and 2002-88294. Moreover, a vinyl polymer in which a dissociating group has been introduced into a terminal of a polymer chain by radical polymerization of a vinyl monomer using either chain transfer agent or polymerization initiator having a dissociating group (or a substituent that can be converted to a dissociating group) or an iniferter or by ion polymerization using a compound having a dissociating group (or a substituent that can be converted to a dissociating group) in either an initiator or a stopper also can be used.

Preferable examples of a condensed polymer and a monomer which configures the condensed polymer include substances described in JP-A No. 2001-247787.

The self-dispersing polymer particles used in the present invention preferably includes a water-insoluble polymer containing a hydrophilic structural unit and a structural unit derived from an aromatic group-containing monomer from the viewpoint of self-dispersibility.

There is no limitation on the hydrophilic structural unit insofar as it is derived from a hydrophilic group-containing monomer, and may be derived from one hydrophilic group-containing monomer or may be derived from two or more hydrophilic group-containing monomers. The hydrophilic group is not limited and may be a dissociating group or a nonionic hydrophilic group.

The hydrophilic group is preferably a dissociating group, and more preferably an anionic dissociating group, from the viewpoints of promoting the self-dispersibility and improving stability of the emulsion state or dispersion state of the self-dispersible polymer particles. Examples of the dissociating group include a carboxyl group, a phosphoric acid group, and a sulfonic acid group. Among the above, the carboxyl group is preferable from the viewpoint of fixing property when the ink composition is formed therewith.

The hydrophilic group-containing monomer used in the present invention is preferably a dissociating group-containing monomer from the viewpoints of self-dispersibility and aggregation properties, and specifically, the hydrophilic group-containing monomer is preferably a dissociating group-containing monomer having a dissociating group and an ethylenically unsaturated bond.

Examples of the dissociating group-containing monomer include an unsaturated carboxylic acid monomer, an unsaturated sulfonic acid monomer, and an unsaturated phosphoric acid monomer.

Specific examples of the unsaturated carboxylic acid monomer include acrylic acid, methacrylic acid, crotonic acid, itaconic acid, maleic acid, fumaric acid, citraconic acid, and 2-methacryloyloxy methylsuccinic acid. Specific examples of the unsaturated sulfonic acid monomer include styrene sulfonic acid, 2-acrylamido-2-methyl propane sulfonic acid, 3-sulfopropyl (meth)acrylate, and bis-(3-sulfopropyl)-itaconate. Specific examples of the unsaturated phosphoric acid monomer include vinyl phosphoric acid, vinyl phosphate, bis(methacryloxyethyl)phosphate, diphenyl-2-acryloyloxyethyl phosphate, diphenyl-2-methacryloyloxyethyl phosphate, and dibutyl-2-acryloyloxyethyl phosphate.

Among the dissociating group-containing monomers, from the viewpoint of dispersion stability and ejection stability, the unsaturated carboxylic acid monomer is preferable, an acrylic monomer is more preferable, and acrylic acid and methacrylic acid are still more preferable.

In preferable embodiments, the self-dispersible polymer particles employed in the invention contain a polymer having a carboxyl group, and still more preferably a polymer having a carboxyl group and an acid value (mgKOH/g) of 25 to 100 from the viewpoints of improving self-dispersibility and an aggregation rate when the ink composition is brought into contacts with a fixing agent liquid. In more preferable embodiments, the acid value is from 25 to 80, and in particularly preferable embodiments, the acid value is in the range of from 30 to 65, from the viewpoints of improving self-dispersibility and an aggregation rate when the ink composition is brought into contacts with a fixing agent liquid.

Stability of the dispersion state of the self-dispersible polymer particles can be favorable when the acid value is 25 or more, and the aggregation properties can be improved when the acid value is 100 or lower.

There is no limitation on the aromatic group-containing monomer insofar as it is a compound containing an aromatic group and a polymerizable group. The aromatic group may be a group derived from an aromatic hydrocarbon or a group derived from an aromatic heterocyclic ring. In the present invention, the aromatic group is preferably an aromatic group derived from an aromatic hydrocarbon from the viewpoint of particle shape stability in an aqueous medium.

The polymerizable group may be a condensation polymerizable group or an addition polymerizable group. In the present invention, from the viewpoint of particle shape stability of the self-dispersible polymer particles in the aqueous medium, the polymerizable group preferably an addition polymerizable group, and more preferably a group containing an ethylenically unsaturated bond.

The aromatic group-containing monomer used in the present invention is preferably an aromatic group derived from aromatic hydrocarbon and a monomer having an ethylenically unsaturated bond. The aromatic group-containing monomers may be used singly or in combination of two or more.

Examples of the aromatic group-containing monomer include phenoxyethyl(meth)acrylate, benzyl(meth)acrylate, phenyl(meth)acrylate, and a styrene monomer. From the viewpoints of well-balancing hydrophilicity and hydrophobicity of the polymer chain of the self-dispersible polymer particles and ink fixing property, the aromatic group-containing monomer is preferably an aromatic group-containing (meth)acrylate monomer, more preferably at least one selected from the group consisting of phenoxyethyl(meth)acrylate, benzyl(meth)acrylate, and phenyl(meth)acrylate, and still more preferably phenoxyethyl(meth)acrylate, and benzyl(meth)acrylate.

The “(meth)acrylate” refers to acrylate or methacrylate.

The self-dispersible polymer particles used in the present invention is preferably a acrylic resin containing a structural unit derived from a (meth)acrylate monomer, more preferably a acrylic resin containing a structural unit derived from an aromatic group-containing (meth)acrylate, and further preferably a acrylic resin containing a structural unit derived from an aromatic group-containing (meth)acrylate, the content of which being from 10% by mass to 95% by mass. When the content of the aromatic group-containing (meth)acrylate is from 10% by mass to 95% by mass, self-emulsifying property or stability of the dispersion state is improved, and moreover an increase in ink viscosity can be suppressed.

In the present invention, the content of the aromatic group-containing (meth)acrylate is more preferably from 15% by mass to 90% by mass, further preferably from 15% by mass to 80% by mass, and particularly preferably from 25% by mass to 70% by mass, from the viewpoints of improvement in stability of self-dispersion state, stabilization of the particle shape in an aqueous medium due to hydrophobic interaction between aromatic rings or between alicyclic hydrocarbon groups, and reduction in the amount of water-soluble components due to appropriate hydrophobization of particles.

The self-dispersible polymer particles used in the invention can be formed by using, for example, a structural unit derived from an aromatic group-containing monomer and a structural unit derived from a dissociating group-containing monomer. The self-dispersible polymer particles may further contain other structural units as needed.

While there is no limitation on a monomer which forms the other structural unit insofar as it can be copolymerized with the aromatic group-containing monomer and the dissociating group-containing monomer, from the viewpoint of flexibility of the main chain skeleton of the water-insoluble polymer or ease of regulation of glass transition temperature (Tg), an alkyl group-containing monomer is preferable.

Examples of the alkyl group-containing monomer include (meth)acrylate monomers and (meth)acrylamide monomers. Examples of the (meth)acrylate monomers include alkyl(meth)acrylates, such as methyl(meth)acrylate, ethyl(meth)acrylate, isopropyl(meth)acrylate, n-propyl(meth)acrylate, n-butyl(meth)acrylate, isobutyl(meth)acrylate, t-butyl(meth)acrylate, hexyl(meth)acrylate, or ethylhexyl(meth)acrylate; ethylenically unsaturated monomers having a hydroxyl group, such as hydroxymethyl(meth)acrylate, 2-hydroxyethyl(meth)acrylate, 2-hydroxypropyl(meth)acrylate, 4-hydroxybutyl(meth)acrylate, hydroxypentyl(meth)acrylate, or hydroxyhexyl(meth)acrylate; and dialkylamino alkyl(meth)acrylates, such as dimethylaminoethyl(meth)acrylate. Examples of the (meth)acrylamide monomers include N-hydroxyalkyl(meth)acrylamides, such as N-hydroxymethyl(meth)acrylamide, N-hydroxyethyl(meth)acrylamide, or N-hydroxybutyl(meth)acrylamide; and N-alkoxyalkyl(meth)acrylamides, such as N-methoxymethyl(meth)acrylamide, N-ethoxymethyl(meth)acrylamide, or N-(n-, iso)butoxymethyl(meth)acrylamide.

The molecular weight range of the water-insoluble polymer which configures the self-dispersible polymer particles used in the present invention is, in terms of weight average molecular weight, preferably from 3,000 to 200,000, more preferably from 5,000 to 150,000, and still more preferably from 10,000 to 100,000. By adjusting the weight average molecular weight to 3,000 or more, the content of water-soluble components can be effectively reduced. By adjusting the weight average molecular weight to 200,000 or less, stability of self-dispersibility can be increased.

The weight average molecular weight is measured with a gel permeation chromatography (GPC). As a GPC instrument, HLC-8220GPC manufactured by Tosoh Corporation, is used; there columns of TSKgel Super Multipore HZ-H (manufactured by Tosoh Corporation, 4.6 mmID×15 cm) are used and connected in tandem; and THF (tetrahydrofuran) is used as an eluent. Further measurement conditions are set as follows.

Sample concentration: 0.35% by mass
Flow rate: 0.35 ml/min
Injected amount of sample: 10 μl
Measuring temperature: 40° C.
Measurement is conducted using an I R detector.
The calibration curve is prepared from 8 samples of “Standard sample TSK standard, polystyrene”: “F-40”, “F-20”, “F-4”, “F-1”, “A-5000”, “A-2500”, “A-1000” and “n-PROPYL BENZENE” (all trade names, manufactured Tosoh Corporation).

From the viewpoint of regulation of hydrophilicity and hydrophobicity of a polymer, the water-insoluble polymer which configures the self-dispersible polymer particles used in the invention preferably contains a structural unit derived from the aromatic group-containing (meth)acrylate (preferably a structural unit derived from phenoxyethyl(meth)acrylate and/or a structural unit derived from benzyl(meth)acrylate,), wherein the content (copolymerization ratio) of the structural unit derived from the aromatic group-containing (meth)acrylate is preferably from 15% by mass to 80% by mass with respect to the total amount of self-dispersible polymer particles.

From the viewpoint of regulation of hydrophilicity and hydrophobicity of a polymer, in preferable embodiments, the water-insoluble polymer preferably contains a structural unit derived from the aromatic group-containing (meth)acrylate monomer and a structural unit derived from a carboxyl group-containing monomer and a structural unit derived from an alkyl group-containing monomer (preferably a structural unit derived from alkyl ester of (meth)acrylic acid wherein the content (copolymerization ratio) of the structural unit derived from the aromatic group-containing (meth)acrylate monomer is preferably from 15% by mass to 80% by mass with respect to a total amount of self-dispersible polymer particles. In more preferable embodiments, the water-insoluble polymer contains a structural unit derived from phenoxyethyl(meth)acrylate and/or a structural unit derived from benzyl(meth)acrylate and a structural unit derived from a carboxyl group-containing monomer and a structural unit derived from an alkyl group-containing monomer (preferably a structural unit derived from alkyl ester of (meth)acrylic acid, the alkyl moiety having 1 to 4 carbon atoms), wherein the content (copolymerization ratio) of the structural unit derived from phenoxyethyl(meth)acrylate and/or the structural unit derived from benzyl(meth)acrylate is from 15% by mass to 80% by mass with respect to the total amount of self-dispersible polymer particles. In addition, the water-insoluble polymer preferably has the acid value of from 25 mgKOH/g to 100 mgKOH/g and the weight average molecular weight of from 3,000 to 200,000, and more preferably has the acid value of from 30 to 90 and the weight average molecular weight of from 5,000 to 150,000.

Hereinafter, exemplary compounds B-01 to B-19 are shown as specific examples of the water-insoluble polymer which configures the self-dispersible polymer particles, although the invention is not limited thereto. The ratio in brackets represents the mass ratio of copolymerization components.

B-01: Phenoxyethyl acrylate/Methyl methacrylate/Acrylic acid copolymer (50/45/5)
B-02: Phenoxyethyl acrylate/Benzyl methacrylate/Isobutyl methacrylate/Methacrylic acid copolymer (30/35/29/6)
B-03: Phenoxyethyl methacrylate/Isobutyl methacrylate/Methacrylic acid copolymer (50/44/6)
B-04: Phenoxyethyl acrylate/Methyl methacrylate/Ethylacrylate/Acrylic acid Copolymer (30/55/10/5)
B-05: Benzyl methacrylate/Isobutyl methacrylate/Methacrylic acid copolymer (35/59/6)
B-06: Styrene/Phenoxyethyl acrylate/Methyl methacrylate/Acrylic acid copolymer (10/50/35/5)
B-07: Benzyl acrylate/Methyl methacrylate/Acrylic acid copolymer (55/40/5)
B-08: Phenoxyethyl methacrylate/Benzyl acrylate/Methacrylic acid copolymer (45/47/8)
B-09: Styrene/Phenoxyethyl acrylate/Butyl methacrylate/Acrylic acid copolymer (5/48/40/7)
B-10: Benzyl methacrylate/Isobutyl methacrylate/Cyclohexyl methacrylate/Methacrylic acid copolymer (35/30/30/5)
B-11: Phenoxyethyl acrylate/Methyl methacrylate/Butyl acrylate/Methacrylic acid copolymer (12/50/30/8)
B-12: Benzyl acrylate/Isobutyl methacrylate/Acrylic acid copolymer (93/2/5)
B-13: Styrene/Phenoxyethyl methacrylate/Butyl acrylate/Acrylic acid copolymer (50/5/20/25)
B-14: Styrene/Butyl acrylate/Acrylic acid copolymer (62/35/3)
B-15: Methyl methacrylate/Phenoxyethyl acrylate/Acrylic acid copolymer (45/51/4)
B-16: Methyl methacrylate/Phenoxyethyl acrylate/Acrylic acid copolymer (45/49/6)
B-17: Methylmethacrylate/Phenoxyethyl acrylate/Acrylic acid copolymer (45/48/7)
B-18: Methyl methacrylate/Phenoxyethyl acrylate/Acrylic acid copolymer (45/47/8)
B-19: Methylmethacrylate/Phenoxyethyl acrylate/Acrylic acid Copolymer (45/45/10)

There is no particular limitation on a method of producing the water-insoluble polymer which configures the self-dispersible polymer particles used in the present invention. Examples of the method include a method of performing emulsion polymerization in the presence of a polymerizable surfactant to covalently bind a surfactant and a water-insoluble polymer; and a method of copolymerizing a monomer mixture containing the above-described hydrophilic group-containing monomer and the above-described aromatic group-containing monomer by known polymerization methods such as a solution-polymerization method or a block-polymerization method. Among these polymerization methods, the solution-polymerization method is preferable, and the solution-polymerization method using an organic solvent is more preferable, from the viewpoint of aggregation rate and droplet-spotting stability when the self-dispersible polymer particles are employed in the ink composition.

From the viewpoints of aggregation rate, it is preferred that the self-dispersing polymer used in the present invention contains a polymer synthesized in an organic solvent, the polymer containing a carboxy group (the polymer preferably has an acid value of from 25 mgKOH/g to 100 mgKOH/g, more preferably an acid value of from 30 mgKOH/g to 90 mgKOH/g, still more preferably an acid value of from 35 mgKOH/g to 65 mgKOH/g) and the polymer being prepared in the form of a polymer dispersion using water as a continuous phase in which the carboxy group is partially or entirely neutralized. That is, the preparation of self-dispersing polymer used in the present invention is carried out by synthesizing a polymer in an organic solvent and preparing an aqueous dispersion in which the carboxy group of the polymer is at least partially neutralized.

The dispersing process preferably includes the following processes (1) and (2).

Process (1): Stirring a mixture containing a first polymer (water-insoluble polymer), an organic solvent, a neutralizer, and an aqueous medium; and

Process (2): Removing the organic solvent from the mixture.

The process (1) preferably includes obtaining a dispersion by, at first, dissolving a polymer (water-insoluble polymer) in an organic solvent, and then gradually adding a neutralizer and an aqueous medium, and mixing and stirring the mixture. The addition of the neutralizer and the aqueous medium to a solution of the water-insoluble polymer dissolved in an organic solvent makes it possible to obtain self-dispersible polymer particles having particle diameters capable of imparting higher storage stability without strong shearing force.

There is no limitation on a stirring method of the mixture, and generally-used mixing and stirring devices or, as required, dispersers such as an ultrasonic disperser or a high voltage homogenizer can be used.

Preferable examples of the organic solvent include an alcohol solvent, a ketone solvent, and an ether solvent.

Examples of the alcohol solvent include isopropyl alcohol, n-butanol, t-butanol, and ethanol. Examples of the ketone solvent include acetone, methyl ethyl ketone, diethyl ketone, and methyl isobutyl ketone. Examples of the ether solvent include dibutyl ether and dioxane. Among these solvents, the ketone solvent such as methyl ethyl ketone or the alcohol solvent such as isopropyl alcohol is preferable. It is also preferable to use isopropyl alcohol and methyl ethyl ketone in combination so that the change in polarity at the time of phase inversion from an oil phase to a water phase can be moderated. By using the solvents in combination, self-dispersible polymer particles having fine particle diameters, that can be free from aggregation-precipitation or fusion of particles and can have high dispersion stability, can be obtained.

The neutralizer is used for forming an emulsion state or a dispersion state in which the dissociating group is partially or thoroughly neutralized whereby the self-dispersible polymer is stabilized in water. Examples of the neutralizer which can be used when the self-dispersible polymer employed in the invention has an anionic dissociating group (e.g., a carboxyl group) as the dissociating group include basic compounds such as organic amine compounds, ammonia, or hydroxides of alkali metals. Examples of the organic amine compound include monomethylamine, dimethylamine, trimethylamine, monoethylamine, diethylamine, triethylamine, monopropylamine, dipropylamine, monoethanolamine, diethanolamine, triethanolamine, N,N-dimethyl-ethanolamine, N,N-diethyl-ethanolamine, 2-dimethylamino-2-methyl-1-propanol, 2-amino-2-methyl-1-propanol, N-methyldiethanolamine, N-ethyldiethanolamine, monoisopropanolamine, diisopropanolamine, and tri-isopropanolamine. Examples of the hydroxides of alkali metals include lithium hydroxide, sodium hydroxide, and potassium hydroxide. Among the above, from the viewpoint of stabilization of dispersion of the self-dispersible polymer particles employed in the invention in water, sodium hydroxide, potassium hydroxide, triethylamine, and triethanolamine are preferable.

The content of the basic compound is preferably from 5 to 120% by mol, more preferably from 10 to 110% by mol, and still more preferably from 15 to 100% by mol, with respect to 100% by mol of the dissociating groups. Stabilization of the dispersion of the particles in water can be further demonstrated when the content of the basic compound is adjusted to 15% by mol or more. Reduction in content of the water-soluble components can be effected when the content of the basic compound is adjusted to 100% by mol or less.

In the process (2), an aqueous dispersion of the self-dispersible polymer particles can be obtained by inverting a phase of the dispersion, which has been obtained in the process (1), to a water phase as a result of distilling off the organic solvent from the dispersion by a common procedure such as vacuum distillation. The thus-obtained aqueous dispersion is substantially free of the organic solvent. Specifically, the amount of the organic solvent contained in the aqueous dispersion is preferably 0.2% by mass or less, and more preferably 0.1% by mass or less.

The average particle diameter of the self-dispersible polymer particles is preferably in the range of from 10 nm to 400 nm, more preferably in the range of from 10 nm to 200 nm, and still more preferably in the range of from 10 nm to 100 nm in terms of volume-average particle diameter. When the volume-average particle diameter is 10 nm or more, production suitability of the polymer particles may be increased. When the volume-average particle diameter is 400 nm or less, the storage stability may be increased. The particle size distribution of the self-dispersible polymer particles is not particularly limited. The polymer particles may have either a broad particle size distribution or a monodisperse particle size distribution. Two or more kinds of water-insoluble particles may be used in combination as a mixture.

In addition, the volume-average particle diameter and particle diameter distribution of the self-dispersing polymer particles thus obtained were measured using a NANOTRAC particle size distribution meter (trade name: UPA-EX150, manufactured by Nikkiso Co., Ltd.) by a dynamic light scattering method.

From the viewpoints of storage stability of the aqueous ink, the glass transition temperature (Tg) of the self-dispersing polymer is preferably 30° C. or higher, more preferably 40° C. or higher, and still more preferably 50° C. or higher.

The self-dispersing polymer particle may be used alone or in combination of two or more thereof.

From the viewpoints of aggregation speed, rub resistance of images and glossiness, a content of a first anionic polymer in the ink composition is preferably from 0.5 to 30% by mass, more preferably from 1 to 15% by mass, and still more preferably from 2 to 10% by mass, with respect to a total amount of the ink composition. In the case where the self-dispersing polymer particles are used as the first anionic polymer, the content of self-dispersing polymer particle is the same as described above.

From the viewpoints of rub resistance of images, a ratio (mass ratio) of the pigment and the first anionic polymer in the ink composition (self-dispersing pigment/first anionic polymer) is preferably from 1/0.5 to 1/10, more preferably from 1/1 to 1/4. In the case where the self-dispersing polymer particles are used as the first anionic polymer, the ratio of the pigment and the self-dispersing polymer particle in the ink composition is the same as described above.

Self-Dispersing Pigment

The term “self-dispersing pigment” used in the present invention refers to a pigment which is treated so that the surface of the pigment has at least one functional group (dispersibility-imparting group) selected from the group consisting of —COOH, —CHO, —OH, —SO₃H and salts thereof which allows the pigment to be homogeneously dispersed in an aqueous ink composition without additionally mixing with a dispersing agent. In addition, the term “dispersion” herein used refers to a state in which a self-dispersing pigment is stable in water in the absence of a dispersing agent and includes a state in which the self-dispersing pigment is dispersed or dissolved therein.

In the ink composition containing the self-dispersing pigment, superior dispersion stability and moderate viscosity of ink composition can be achieved ss compared to common ink compositions containing both a non-self-dispersing pigment and a dispersing agent. As a result, it is possible to contain a greater amount of pigment in the composition, and in particular, images with favorable color density can be formed on a plain paper.

Pigments that can form the self-dispersing pigment are the same as those used in common ink compositions for ink jet. Examples thereof include organic pigments such as azo lake, insoluble azo pigments, condensed azo pigments, chelate azo pigments, phthalocyanine pigments, perylene pigments, perynone pigments, quinacridone pigments, thioindigo pigments, isoindolinone pigments, quinophthalone pigments, dioxazine pigments, anthraquinone pigments, nitro pigments, nitroso pigments and aniline black; inorganic pigments such as titanium white, zinc flower, white lead, carbon black, colcothar, red pigments, cadmium red, chrome yellow, ultramarine blue, cobalt blue, cobalt violet and zincromate. In addition, though a pigment is not described in the color index, any pigment may be used so long as it can be dispersed in an aqueous phase. Of these, it is particularly preferred to use azo lake, insoluble azo pigments, condensed azo pigments, chelate azo pigments, phthalocyanine pigments, perylene pigments, perynone pigments, quinacridone pigments, thioindigo pigments, isoindolinone pigments, quinophthalone pigments, dioxazine pigments and anthraquinone pigments. In addition, the term “pigment” refers to a particulate solid ordinarily insoluble in water, a solvent or oil.

The self-dispersing pigment can be prepared by coordinating or grafting a functional group or a molecule containing a functional group on the surface of pigment by a physical treatment such as vacuum plasma or chemical treatment. For example, the self-dispersing pigment can be obtained in accordance with the method disclosed in JP A-No. 8-3498. In addition, the self-dispersing pigment may be available from commercialized products and examples of preferable commercialized products include MICRO JET series (trade name, manufactured by Orient Chemical Industries Co., Ltd.) and CAB-O-JET series (trade name, manufactured by Cabot Japan K.K.).

From the viewpoints that the self-dispersing pigment reacts with an acidic precipitant contained in the fixing agent liquid thereby improving both aggregability and rubresistance of ink, a self-dispersing pigment having a carboxy group (—COOH) on the surface thereof is preferred.

From the viewpoints of improving storage stability of ink and preventing clogging of nozzles, the self-dispersing pigment preferably has an average particle diameter of from 10 nm to from 300 nm, and more preferably from 40 nm to 150 nm.

A content of self-dispersing pigment in the ink composition is preferably from 1 to 15% by mass from the viewpoints of securing sufficient OD value and liquid stability of ink composition, more preferably from 2 to 10% by mass from the viewpoints of ejection stability.

Pigment Covalently Bonded with a Second Anionic Polymer

The self-dispersing pigment used in the present invention is preferably a pigment covalently bonded with a second anionic polymer, and in this case, continuous ejectionability of ink is further improved. The pigment covalently bonded with a second anionic polymer contains at least one second anionic polymer and a pigment. In this case, the second anionic polymer is covalently bonded to the pigment. The pigment covalently bonded with a second anionic polymer (hereinafter, also referred to as an “anionic polymer-bonded pigment” or a “polymer-modified pigment”) is a pigment that can be dispersed in an ink-constituting aqueous medium without using an additional dispersing agent.

The anionic polymer-bonded pigment contains a known pigment as a colorant without particular limitation. The ink used in the present invention can be prepared in the form of yellow colored ink, magenta colored ink, cyan colored ink, black colored ink, red colored ink, green colored ink or blue colored ink by changing a color hue of the colorant.

The pigment may be any pigment ordinarily used by those skilled in the art such as carbon products and organic color pigments including blue, black, brown, cyan, green, white, violet, magenta, red, orange, or yellow organic pigments. A mixture of different kinds of pigments may be used. Examples of carbon products include graphite, carbon black, glassy carbon, activated carbon, carbon fibers and activated carbon black. Representative examples of carbon black are disclosed in Japanese Patent national phase application publication (JP-T) No. 2008-531762, the paragraph 0012. However, the present invention is not limited thereto.

Examples of preferred organic color pigments include anthraquinone, phthalocyanine blue, phthalocyanine green, diazo, monoazo, pyranthrone, perylene, heterocyclic yellow, quinacridone, quinolonoquinolone, and (thio)indigoide. Examples of other favorable organic color pigments are disclosed in Colour Index, 3^{rd} edition (The Society of Dyers and Colourists, 1982).

In addition, the pigment may be a pigment such as carbon products oxidized using an oxidizing agent for introducing an ionic and/or ionizable group into the surface of the pigment. The oxidized pigment thus prepared has a group containing a high-degree of oxygen group on the surface thereof. Examples of oxidizing agent include an oxygen gas; ozone; peroxides such as hydrogen peroxide; persulfates including sodium persulfate and potassium persulfate; hypohalous acid such as sodium hypochlorite; oxidizing acid such as nitric acid; sodium perchlorate, nitrogen oxide including NO₂; transition metal-containing oxidizing agents such as permaganate salts, osmium tetraoxide or chromium oxide; and eerie ammonium nitrate. However, oxidizing agents are not limited thereto. A mixture of the oxidizing agents, in particular, a mixture of gasous oxidizing agents such as oxygen and ozone may be used. In order to introduce an ionic or ionizable group, pigments which have been modified by using surface modification method such as sulfonylation may also be used.

The pigment may also be a multiphase aggregate comprising a carbon phase and a silicon-containing species phase or a multiphase aggregate comprising a carbon phase and a metal-containing species phase. The multiphase aggregate containing the carbon phase and the silicon-containing species phase can also be considered a silicon-treated carbon black aggregate and the multiphase aggregate containing a carbon phase and a metal-containing species phase can be considered to be a metal-treated carbon black aggregate as long as one realizes that in either case, the silicon-containing species and/or metal-containing species are a phase of the aggregate just like the carbon phase. The multiphase aggregates do not represent a mixture of discrete carbon black aggregates and discrete silica or metal aggregates. Rather, the multiphase aggregates that can be used as the pigment in the present invention include at least one silicon-containing or metal-containing region concentrated at or near the surface of the aggregate (but put of the aggregate) and/or within the aggregate. The aggregate, thus contains at least two phases, one of which is carbon and the other of which is a silicon-containing species, a metal-containing species, or both. The silicon-containing species that can be a part of the aggregate is not attached to a carbon black aggregate like a silane coupling agent would be, but actually is part of the same aggregate as the carbon phase.

The metal-treated carbon blacks are aggregates containing at least a carbon phase and a metal-containing species phase. The metal-containing species include compounds containing aluminum, zinc, magnesium, calcium, titanium, vanadium, cobalt, nickel, zirconium, tin, antimony, chromium, neodymium, lead, tellurium, barium, cesium, iron, and molybdenum. The metal-containing species phase can be distributed through at least a portion of the aggregate and is an intrinsic part of the aggregate. The metal-treated carbon black may also contain more than one type of metal-containing species phase or the metal-treated carbon black can also contain a silicon-containing species phase and/or a boron-containing species phase.

Details of preparation of these multi-phase aggregates are disclosed in U.S. patent application Publication Ser. No. 08/446,141, U.S. patent application Publication Ser. No. 08/446,142, U.S. patent application Publication Ser. No. 08/528,895, U.S. patent application Publication Ser. No. 08/750,017, WO 96/37547, WO 08/828,785, WO 08/837,493, and WO 09/061,871.

The silica-coated carbon product may be used as the pigment and is disclosed in WO 96/37547. In addition, any silica-coated pigment may be used. Based on the same reason that such a coated pigment is the metal-treated carbon black and multi-phase aggregate, a coupling agent having a functionality that is capable of reaction with a thin film or silica or metal phase may be used in order to impart a required or desired functionality to the pigment.

The pigment can have a wide range of BET surface areas, as measured by nitrogen adsorption, depending on the desired properties of the pigment. For example, the pigment surface are may be from about 10 m²/g to about 2000 m²/g including from about 10 m²/g to about 1000 m²/g and from about 50 m²/g to about 500 m²/g. As is known to those skilled in the art, a higher surface area will correspond to a smaller particle size, for the same particle structure. If a higher surface area is preferred and is not readily available for the desired application, it is also well recognized by those skilled in the that the pigment may be subjected to conventional size reduction or comminution techniques, such as media milling, jet milling, microfluidization, or sonication to reduce the pigment to a smaller particle size, if desired. In addition, when the pigment is a particulate material comprising aggregates of primary particles, such as carbon black, the pigment may have a structure which ranges from about 10 cc/100 g to about 1000 cc/100 g, including from about 40 cc/100 g to about 200 cc/100 g.

The anionic polymer-bonded pigment has a structure in which at least one anionic group or anionizable group is bonded to at least one polymer bonded to the pigment is bonded to. The term “anionizable group” used herein refers to a group that can be ionized so as to have an anionic property. For example, the anionic group or anionizable group may be an acidic group or a salt thereof.

Examples of the acidic group include a carboxyacid group, a hydroxyl group, a sulfonic acid group, a sulfate group, and phosphonic acid group. These acid groups may be derived from organic acid having the above acid. The anionic group or anionizable group brings a functional group associated with aggregation with fixing agent liquid and anionic polymer-bonded pigment to the surface of the recording medium.

Polymers that are contained in the anionic polymer-bonded pigment are not particularly limited and examples thereof include polystyrene, styrene/acrylic copolymers, styrene/acrylate copolymers, polyacrylates, polymethacrylates, polyethyl acrylates, styrene/butadiene copolymers, butadiene copolymers, polyurethane, acrylonitrile/butadiene copolymers, chloroprene copolymers, cross-linked acrylic resins, cross-linked styrene resins, polyvinylidene fluoride, benzoguanamine resins, polyethylene resins, polypropylene resins, styrene/methacrylate copolymer, styrene/acrylamide copolymer, poly (n- or isobutylacrylate), polyvinyl acetate, polyacrylamide, polyvinyl acetal, rosin resins, polyvinylidene chloride resins, ethylene/vinyl acetate copolymers, vinyl acetate/acryl copolymers, and vinyl chloride resins. The polymer may be present on the pigment in an amount of from about 20% by mass to about 30% by mass with respect to the anionic polymer-bonded pigment.

The polymer-modified pigment is prepared by a process including polymerizing at least one polymerizable monomer from a modified pigment described below. The polymer group, for example, may be selected from various kinds of polymer groups including homopolymers, random copolymers, block copolymers, graft copolymers, branched copolymers, and alternating copolymers.

In General, there are three types of methods for preparing the pigment having attached at least one polymeric group. These methods are sometimes referred to as “grafting onto”, “grafting through” and “grafting from”. The process “grafting from” generally includes polymerization of a monomer in the presence of a modified pigment having at least one polymerizable group bonded thereto. The bonded polymer may sterically hinder growing polymer chains from reaching the polymerizable group on the surface of pigment. Accordingly, the presence of the bonded polymer may limit new bonding. Furthermore, the process “grafting from” typically includes forming an initiating point on the surface of the pigment and directly polymerizing a monomer from the initiating point.

The polymer-modified pigment used in the present invention is preferably prepared by the process of “grafting from”. The process of “grafting from” known in the art may be used. For example, the polymer-modified pigment may be prepared by a process in which at least one polymerizable monomer is polymerized “from” a pigment having at least one transferable atom or group bonded to the pigment. Alternatively, a conventional radical polymerization may be used in which at least one polymerizable monomer is polymerized from the pigment having an initiating group bonded thereto. Preferably, the polymer-modified pigment is prepared by a polymerization process including a step of polymerizing at least one polymerizable monomer from a pigment having at least one transferable atom or group bonded thereto. Examples of polymerization include ionic polymerization such as group transfer polymerization (GTP), atom transfer radical polymerization (ATRP), stable free radical (SFR) polymerization, and reversible addition-fragmentation chain transfer (RAFT) polymerization. These polymerizations typically, but is not necessarily, include a relatively low stationary concentration of propagating chain ends in relation to dormant chain ends. When the chain is in the dormant state, the chain ends includes a transferable atom or group. The dormant chain end may be converted to propagating chain end by loss of the transferable atom or group.

ATRP, SFR and RAFT are living radical polymerization methods which are used to prepare polymeric materials from radically polymerizable monomers using an initiator containing a radically transferable atom or group. These methods are different in the type of group being transferred. For example, ATRP polymerizations typically involve the transfer of halogen groups. Details concerning the ATRP process are disclosed in, for example, by Matyjaszewski in Journal of the American Chemical Society, vol. 117, page 5614 (1995), as well as in ACS Symposium Serves 768, and Handbook of Radical Polymerization, Wiley-Interscience, Hoboken 2002, Matyjaszewski, K. and Davis T. (Editors). SFR polymerizations generally involve transfer of stable free radical groups such as nitroxyl groups. Details concerning nitroxide-mediated polymerization are disclosed, for example, in the chapter 10 pf The Handbook of Radical Polymerization, K. Matyjaszewski & T. Davis Ed., John Wiley Interscience, Hoboken 2002. For example, various different groups are disclosed in Accounts of Chemical Research 2004 37 (5), 312-325 (C. L. McCormick and A. B. Lowe), but a RAFT process disclosed in Macromolecules 1998 31(16), 5559 (Chiefari, et al.) is different from nitroxide-mediated polymerization in that the transfer group is for example a thiocarbonylthio group. In comparison, GTP is a method for polymerizing an anionic or cationic polymerizable monomer from an initiator containing an ionically transferable atom or group such as silyl group (for example, trimethylsilyl group). Details of the GTP process are disclosed, for example, in Journal of the American Chemical Society 1983 105(17), 5706-5708 (Webster, et al.), and in Encyclopedia of Polymer Science and Engineering 1987 7, 580-588 (Webster).

In a first embodiment, the polymer-modified pigment is preferably prepared by a process including the step of polymerizing at least one radically polymerizable monomer from a modified pigment including a pigment having attached at least one radical transferable atom or group. The radically polymerizable monomer is polymerized “from” the modified pigment. Accordingly, this process is a “grafting from” process. Thus, the modified pigment provides the initiation sites for the polymerization.

The type of radically transferable atom or group contained in the modified pigment depends on the radical polymerization process used. In the ATRP process, the radically transferable atom or group may contain halogen such as a haloalkyl ester group, a haloalkyl ketone group, and haloalkyl amide group. Preferably, the halogen is chlorine or bromide. For RAFT process, the radically transferable atom or group may include a thiocarbonylthio group while, for SFR processes, the radically transferable atom or group may include a nitroxide group.

The radically transferable atom or group may be directly attached to the pigment, or may be attached to the pigment through one or two linking groups.

For example, the radically transferable atom or group may be a group represented by the following Formula.

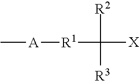

A represents a group bonded to a pigment. A and R¹ may be the same or different and each independently represents a bonded, substituted or unsubstituted arylene, alkylene, aralkylene or alkyl arylene group, —O—, —S—, —NR⁴—, —S(═O)—, —C(═O)—, —COO—, —OC(═O)—, —COO-ALK-OOC— in which ALK represents a branched or non-branched C₂ to C₈ alkylene group such as ethylene, propylene, butylene, isobutylene, pentylene, hexylene or neopentylene groups, —CONR⁴—, —NR⁴C(═O)—, —SO₂—, —P(═O)₂O—, or —P(═OXOR⁴)— in which R⁴ represents a hydrogen atom, an alkyl group or an aryl group. R² and R³ may be the same or different and each independently represents H, an alkyl group, an aryl group, —OR⁵, —NHR⁵, —N(R⁵)₂, or —SR⁵ in which R⁵ each independently represents an alkyl group or an aryl group. X represents a radical transferable atom or group such as halogen.

The modified pigment having these attached groups represented by the afore-mentioned formula may be prepared by any method known in the art. For example, the carbon product containing a carboxylic acid group may reacts with hydroxyalkyl bromide to produce a modified carbon product having an attached Br group. Alternatively, a pigment having attached alcohol group may react with a halogen-containing acylating agent. Additional methods of attaching a radically transferable atom or group to carbon products are disclosed in the specification of U.S. Pat. No. 6,664,312.

The modified pigment may be prepared using any method known to those skilled in the art such that organic chemical groups are attached to the pigment. Preferably, the modified pigment is prepared using the method disclosed, for example, in U.S. Pat. Nos. 5,554,739, 5,707,432, 5,837,045, 5,851,280, 5,885,335, 5,895,522, 5,900,029, 5,922,118, and 6,042,643, and PCT Publication No. WO 99/23174. Another method for preparing the modified pigment includes the step of reacting a pigment having a useful functional group with a reagent containing a radical transferable atom or group. Such a functional pigment may be prepared using a method disclosed in the above-described reference documents. In addition, carbon black-containing functional groups may be prepared by a method disclosed, for example, in U.S. Pat. Nos. 6,831,194, and 6,660,075, US Patent Application Publication Nos. 2003-0101901, and 2001-0036994, CA Patent No. 2351162, EP Patent Nos. 1394221 and 1586607 and PCT Publication No. WO 04/63289.

The radical polymerization process used for preparing the polymer-modified pigment includes the use of at least one radical polymerizable monomer. The radical polymerizable monomer favorably used for the polymerization step contains at least one dien group or at least one vinyl group. Examples of the radical polymerizable monomer include, but are not limited to, acrylic acid, methacrylic acid, acrylic acid esters, methacrylic acid esters, acrylonitriles, cyanoacrylic acid esters, malate diesters and fumarate diesters, vinyl pyridines, vinyl N-alkyl pyrroles, vinyl acetate, vinyl oxazoles, vinyl thiazoles, vinyl pyrimidines, vinyl imidazoles, allyl and vinyl ethers, vinyl ketones, and styrenes. Vinyl ketone includes those in which α- the α-carbon atom of the an alkyl group does not bear a hydrogen atom, such as vinyl ketone in which both α-carbon atoms bear a C₁ to C₄ alkyl group, halogen, etc. or a vinyl phenyl ketone in which the phenyl group may be substituted with from 1 to 5 C₁ to C₆ alkyl groups and/or halogen atoms. Styrene includes styrene include those in which the vinyl group is substituted with a C₁ to C₆ alkyl group, such as the α-carbon atom, and/or those in which the phenyl group is substituted with from 1 to 5 substituents including a C₁ to C₆ alkyl, alkenyl (including vinyl), or an alkynyl group (including acetylenyl), a phenyl group, a haloalkyl group, and functional groups such as C₁ to C₆ alkoxy, halogen, nitro, carboxy, sulfonate, C₁ to C₆ alkoxycarbonyl, hydroxy (including those protected with a C₁ to C₆ acyl group), and cyano groups. Specific examples of the radical polymerizable monomer include methyl acrylate (MA), methyl methacrylate (MMA), butyl acylate (BA), 2-ethyl hexyl acylate (EHA), acrylonitrile (AN), methacrylonitrile, styrene, and derivatives thereof.

In a preferred method for preparing the polymer-modified pigment, the concentration of modified pigment is low in the polymerization step in order to produce polymer-modified pigment having improved properties such as pigment dispersant stability. The modified pigment is present in a solid amount of from about 1% to about 30%, more preferably in a solid amount of from about 2 to about 20%, and still more preferably in a solid amount of from about 5 to about 10%. For example, the modified pigment may be dispersed in a mixture of a polymerizable monomer and at least one solvent such as water, NMP, methanol, anisole, or another organic solvent. The concentration of polymerizable monomer is not particularly limited and may be from about 1% by mass to about 99% by mass. The amount of polymerizable monomer may be varied depending on the amount of modified pigment.

The radical polymerization process may further include addition of at least one transition metal catalyst t, which helps facilitate the transfer of the radical transferable atom or group during polymerization. Suitable transition metal catalysts include those containing a transition metal and a ligand coordinated to the transition metal. For example, the transition metal may contain copper, iron, rhodium, nickel, cobalt, palladium, or ruthenium with a suitable ligand. In some embodiments, the transition metal catalyst contains a copper halide, such as Cu(I) Br or Cu(I) Cl. Any ligand known in the art may be utilized depending on the monomer used for polymerization.

In a preferred method for preparing the polymer-modified pigment, the amount of transition metal catalyst is adjusted in order to prepare a polymer-modified pigment having improved properties, such as pigment dispersion stability. For example, a ratio of the amount of transferable atom or group to the amount of transition metal catalyst is preferably from about 20:1 to about 500:1, more preferably from about 50:1 to about 400:1, and still more preferably from about 100:1 to about 300:1.

In a second embodiment, the polymer-modified pigment is preferably prepared by a process including the step of polymerizing at least one ionically polymerizable monomer from a modified pigment including a pigment having attached at least one ionically transferable atom or group. The ionically polymerized monomer is polymerized “from” the modified pigment. For this reason, this is the process of “grafting from”. In addition, the modified pigment provides the initiation sites for polymerization. Examples of such a method include the afore-mentioned GTP. The term “ionically” includes cationically or anionically. For this embodiment, the pigment may be selected from the afore-mentioned pigments. The transferable atom or group and the polymerizable monomer may be selected from those used for ionic polymerization. For example, the transferable atom or group may include a silyl group such as a trimethyl silyl group, and the polymerizable monomer may be acrylate ester, methacrylate ester, or alkyl vinyl ketone. Other monomers include those disclosed, for example, in U.S. Pat. No. 4,508,880. The modified pigment may be prepared using any of the processes described above.

In a third embodiment, the polymer-modified pigment is preferably prepared by a process including the step of polymerizing at least one polymerizable monomer from a modified pigment including a pigment having attached at least one transferable atom or group. For this embodiment of the process of a “grafting from” process, the polymerizable monomer contains an ionizable group. Any of polymerizable monomer may be used including, for example, acrylic acid, methacrylic acid, vinyl pyridine, dimethyl amino ethyl acrylate, dimethylaminoethyl methacrylate or derivatives thereof. The ionizable groups may then be converted to ionic groups. Thus, the polymer-modified pigment prepared by this process includes a pigment having attached at least one bonded ionic polymer, group.

For this embodiment, transition metal catalysts are preferably used in which the interactions of the catalyst with the reaction media and the reaction components do not prevent the catalyst from being active in the desired polymerization process. It may also be desirable for the transition metal catalyst to be at least partially soluble in the reaction medium, being sufficiently soluble such that at least a portion of the transition metal complex of both oxidation states is soluble in the reaction media. In addition, the transition metal catalyst may also have a low redox potential (such as less than about 500 mV versus NHE); be stable towards ionic species, having an acidicity stability constant of the protonated ligand greater than about 10⁻⁴; have a low propensity to disproportionation, with a conditional disproportionation constant less than about 1000; or has a sufficient conditional metal radically transferable atom or group to act as a catalyst in reaction medium (such as grater than about 10). Preferably, the transition metal catalyst has all of these properties. Preferred catalysts are disclosed in Polymer Preprints 2005 46(2), 482-483 (N. Tsarevsky, B. McKenzie, W. Tang and K. Matyjaszewski). For example, the transition metal catalyst may contain a heterodonor ligand, which may be useful in catalytic reactions in aqueous, polar, acidic, ionic or basic media or with polar, acidic, ionic or basic monomer. The heterodonor ligand may be a bidentate or polidentate ligand. In an acidic medium or other medium which may be a protonated compound, the hetero donor ligand may contain a donor atom which cannot be protonated. The hetero donor ligand may have at least two donor atoms, each respectively selected from the group consisting of oxygen, sulfur, selenium, tellurium, nitrogen, phosphorus, arsenic, antimony, and bismuth. Specific examples of useful heterodonor ligands include sodium salts of ethylene dithiol acetoacetic acid. Useful transition metal catalysts are disclosed in of US Patent Application Publication No. 2004-0122189 in more detail.

For any of the polymerization processes applicable to the preparation of the polymer-modified pigment, the amount of the attached polymeric group may be varied depending on a variety of factors including the particle size of the modified pigment, and the kind and molecular weight of the polymer used. Generally, the amount of polymer is preferably from 10 parts to 1000 parts with respect to 100 parts of the pigment, more preferably from 20 parts to 800 parts, still more preferably from 30 parts to 600 parts, still more preferably from 40 parts to 400 parts, and still more preferably from 50 parts to 200 parts.

In addition, in any polymerization process, there are several preferred methods including use of specific types of polymerizable monomers. Hereinafter, the methods will be described in more detail.

In a preferred first method, at least one of the polymerizable monomer contains a hydrophilic group which is not an ionic group. Examples of the hydrophilic non-ionic group include ether, alcohol and amide groups, but are not limited thereto. Specific examples of polymerizable monomer containing a hydrophilic non-ionic group include 2-hydroxyethyl methacrylate (HEMA); 2-hydroxyethyl acrylate (HEA); N-vinyl pyrrolidone (NVP), N-vinylacetamide (NVAc); esters of acrylic acid and methacrylic acid containing an alkylene oxide group such as polyethylene glycol acrylate or polyethylene glycol methacrylate; and derivatives thereof. Accordingly, the polymer group contains at least one hydrophilic non-ionic functional group. The hydrophilic non-ionic group may be bonded to the skeleton of the polymer group. A pendant group may be a polymer group having a hydrophilic non-ionic group.

Alternatively, the polymeric group including a hydrophilic non-ionic group may be prepared from at least one polymerizable monomer including a reactive group that can be converted into a hydrophilic non-ionic group. Accordingly, the method includes the step of polymerizing at least one polymerizable monomer containing at least one reactive group and may include the step of at least partially converting the reactive group into a hydrophilic non-ionic group. For example, the polymerizable monomer may contain an acetoxy group such as vinyl acetate or an ether group such as vinyl methyl ether and all of them are convertible into an alcohol group.

In the second preferred method, at least one of the polymerizable monomer contains a reactive functional group convertible into a secondary group such as ionic group. Accordingly, the method includes the step of polymerizing at least one polymerizable monomer containing at least one reactive group and at least partially converting the reactive group into a secondary group. Examples of the reactive group include, but are not limited to, epoxy groups (which can be convertible into various secondary groups including a diol group), isocyanate groups (which can be convertible into various secondary groups such as amine, carbamate, urea and biuret), halomethyl styrene groups including chloromethyl styrene groups (which can be convertible into secondary groups such as ammonium methyl styrene or hydroxymethyl styrene) active ester groups including nitro benzylester (convertible into carboxy acid), and esters of sulfonic acid (which can be convertible into sulfonic acid). Preferred are reactive groups that can be convertible into an ionic group. Accordingly, the polymer-modified pigment resulting from this preferred method contains ionic groups.

In one embodiment of this method, the reactive group is an ionizable group including a cationizable group or an anionizable group. The term “ionizable group” refers to a group capable of producing an ionic group. The anionizable group produces an anion and the cationizable group produces a cation. The conversion of the cationizable or anionizable group into the corresponding cationic or anionic group may be performed using any method known in the art. For example, a reactive group that is cationizable may be converted into a cationic group via quaternization (such as by reacting the cationizable group with an alkylating agent or other electrophile substance), or by protonation (such as by subjecting the cationizable group to pH's that are near or below the pKb of the cationizable group). Accordingly, for example, the polymerizable monomer may contain an amino group and the method further includes conversion of the amino group to either a protonated or quaternary ammonium group. Specific examples of the polymerizable monomer containing the cationizable group include dimethylaminoethyl methacrylate (DMAEMA) and other dialkylaminoethyl methacrylates, dimethylaminoethyl acrylates (DMAEA) and other dialkylaminoethyl acrylates, 2-vinyl pyridine (2VP), 4-vinyl pyridine (4VP), and derivatives thereof, but are not limited thereto. In addition, the ionizable group may be an anionizable group (such as a carboxylic acid group and a sulfonic acid group) which can then be converted to ionic groups (such as carboxylate group or a sulfonate group) by deprotonation. Examples of the polymerizable monomer containing an anionizable group include acrylic acid (AA), methacrylic acid (MAA), maleic acid, fumaric acid, itaconic acid, vinyl sulfonic acid, acrylamide methylpropanesulfonic acid (AMPS), and styrene sulfonic acid, but are not limited thereto.

In another embodiment of this method, the reactive group is an ester group convertible into an anionic group. Accordingly, for example, the reactive group is convertible into the corresponding carboxylic acid group by hydrolysis and may be an ester group capable of producing a carboxylate group under hydrolysis conditions. Examples of the polymerizable monomer containing a hydrolysable ester group include esters of acrylic and methacrylic acid such as acrylate and methacrylate esters of C₁ to C₂₀ alcohol, maleic anhydride and derivatives thereof, but are not limited thereto. The reactive group may be an rater that can be converted to the corresponding acid group via dealkylation and is capable of producing a carboxylate group under hydrolysis conditions. In this case, preferred reactive ester groups are t-butylester groups that can be converted to a carboxylic acid salt under specific reaction conditions. Examples of the polymerizable monomer containing a reactive t-butyl group include, but are not limited to, t-butyl methacrylate (tBMA), t-butyl acrylate (tBA), and derivatives thereof.

In a third preferred method, the modified pigment may contain at least one non-transferable atom or group bonded thereto. Accordingly, the modified pigment may contain both transferable atom or groups and non-transferable atom or groups. The above-described method for preparing the modified pigment containing at least one transferable atom or group can be used here. The non-transferable group may have the same structure as shown above for the attached transferable group, however, without the transferable atom, such as an X group described above or a non-halogen containing alkyl group. Additional examples include groups containing an ionic or ionizable group such as a carboxylic acid group containing —C₆H₄—COO—, a sulfonic acid group containing —C₆H₄—SO₃—, and salts thereof.

Any of the processes for preparing the polymer-modified pigment may further include purification using various known techniques. For example, the polymer-modified pigment may be purified by filtration, centrifugation, washing or the like to remove unreacted materials, byproduct salts, and other reaction impurities. The polymer-modified pigment may be separated by evaporating components except for the polymer-modified pigment or may be recovered by filtration and drying. In addition, the modified pigment may be dispersed in a suitable medium and purified in order to remove undesired soluble free species from the resultant dispersion. A known ultra filtration/membrane separation technique using membrane or ion exchange may be used to purify dispersants and remove a substantial amount of free ionic unwanted species.

The average particle diameter of the polymer-modified pigment in the ink composition is preferably from more than 10 nm to not more than 1000 nm, more preferably from more than 20 nm to not more than 500 nm, more preferably from more than 30 nm to not more than 450 nm, particularly preferably from more than 40 nm to not more than 400 nm, most preferably from more than 50 nm to not more than 350 nm.

For the polymer-modified pigment contained in the ink composition, the amount of ionic group contained is preferably about 0.05 mmol or more, more preferably about 0.1 mmol or more, and still more preferably about 0.3 mmol or more per gram of the polymer-modified pigment.

In addition, the polymer group bonded to the polymer-modified pigment is preferably about 12 mmol or less, more preferably about 10 mmol or less, and still more preferably about 4 mmol or less per gram of the polymer-modified pigment.

For example, the polymer-modified pigment may have an attached polymer containing an anionic group such as a carboxylate salt group. In this case, the amount of the anionic group is sometimes refers to as the acid number (value) for the polymer. Accordingly, in the case where the bonded polymer contains an acid group, the polymer preferably has an acid value of about 20 or more, more preferably about 40 or more, still more preferably about 100 or more, and still more preferably about 130 or more. In addition, the acid value is preferably about 800 or less, and more preferably about 400 or less. This value, for example, may be determined by any method known in the art including titration.

In a specific embodiment, the anionic polymer-bonded pigment is a carbon black pigment in which a styrene acrylic polymer is covalently bonded to the surface thereof. In this case, the styrene acrylic polymer preferably has an acid value of about 165 and a molecular weight of about 8,000. The styrene acrylic polymer is preferably present on the carbon black in an amount of about 20% by mass to about 30% by mass with respect to the anionic polymer-bonded pigment. This anionic polymer-bonded carbon black pigment is commercially available from Cabot Corporation (Boston, Mass., United States).

The anionic polymer-bonded pigment is present in the ink composition in an effective amount required for desired image qualities (for example, optical density). For example, the anionic polymer-attached pigment may be present in an amount of from 0.1% to 30% with respect to t a total mass of the ink. From the viewpoint of aggregation rate when the anionic polymer-attached pigment is brought into contact with a fixing agent liquid, the desired content of the anionic polymer-bonded pigment is preferably from 0.5 to 20% by mass, more preferably from 1 to 15% by mass, and still more preferably from 2 to 10% by mass with respect to a total mass of the ink.

Surfactant

The ink used in the present invention preferably contains at least one surfactant. The surfactant is used as a surface tension adjuster. Examples of the surface tension adjuster include nonionic surfactants, cation surfactants, anionic surfactants and betaine surfactants.

The surfactant is preferably contained in the ink in an amount required for adjusting the surface tension of ink composition to the range of from 20 mN/m to 60 mN/m in order to secure spotting of droplets suitable for an ink jet method. Of these, the surfactant content is preferably an amount required for adjusting the surface tension to from 20 mN/m to 45 mN/m, and more preferably from 25 mN/m to 40 mN/m.

The surface tension of the ink composition is measured under conditions of 25° C. by a plate method using an Automatic Surface Tensiometer CBVP-Z (trade name, manufactured by Kyowa Interface Science Co., Ltd).

Specific examples of the surfactant include, as hydrocarbon-based surfactants, anionic surfactants such as fatty acid salts, alkyl sulfuric acid ester salts, alkylbenzene sulfonic acid salts, alkylnaphthalene sulfonic acid salts, dialkylsulfosuccinic acid salts, alkylphosphoric acid ester salts, naphthalene sulfonic acid formalin condensates, polyoxyethylene alkyl sulfuric acid ester salts; and nonionic surfactants such as polyoxyethylene alkylether, polyoxyethylene alkylallylether, polyoxyethylene fatty acid ester, sorbitan fatty acid ester, polyoxyethylene sorbitan fatty acid ester, polyoxyethylene alkylamine, glycerin fatty acid ester, and oxyethylene oxypropylene block copolymers. In addition, it is preferred to use acytylene polyoxyethyleneoxide surfactant ORFIN (trade name, manufactured by Nissin Chemical Industry Co., Ltd.)), SURFYNOLS (trade name, manufactured by AirProducts & ChemicaLs). In addition, amine oxide ampholytic surfactants such as N,N-dimethyl-N-alkylamineoxide are preferable.

In addition, examples of surfactants disclosed in JP-A No. 59-157636, pages 37 to 38, research disclosure No. 308119 (1989) may be used.

In addition, examples of surfactants include fluorine (alkyl fluoride) surfactants and silicone surfactants disclosed in JP-A No. 2003-322926, JP-A No. 2004-325707 and JP-A No. 2004-309806. Rubresistance may be improved by these surfactants.

In addition, these surface tension adjusters may be used as defoaming agents and fluorine compounds, silicone compounds and chelating agents typified by EDTA may be used.

From the viewpoints of improving density unevenness of images, a nonionic surfactant is preferably contained in the ink. Examples of the nonionic surfactant include nonionic ether surfactants, polyoxyethylene oleic acid surfactants, nonionic ester surfactants and nonionic fluorine surfactants.

Examples of the nonionic ether surfactant include, but are not limited to, polyoxyethylene nonylphenyl ether, polyoxyethylene octylphenyl ether, polyoxyethylene dodecylphenyl ether, polyoxyethylene alkyl allyl ether, polyoxyethylene oleyl ether, polyoxyethylene lauryl ether, polyoxyethylene alkyl ether, polyoxyalkylene alkyl ether.

Examples of the nonionic ester surfactant include, but are not limited to, polyoxyethylene oleic acid ester, polyoxyethylene distearic acid ester, sorbitan laurate (salt), sorbitan monostearate (salt), sorbitan monooleate (salt), sorbitan sesquioleate (salt), polyoxyethylene monooleate (salt) and polyoxyethylene stearate (salt).

Examples of the nonionic fluorine surfactant include, but are not limited to, fluoroalkyl ester and perfluoro alkyl carboxylate.

The nonionic surfactant is commercially available and for example, a variety of commercially available products disclosed in the paragraph 0020 of JP-A No. 2006-159907 may be used.

From the viewpoints of efficient improvement of density unevenness of images, a mass ratio of the nonionic surfactant to ink is 1% by mass or less, more preferably 0.5% by mass or less, and still more preferably 0.3% by mass or less.

Other Additives

The ink use in the present invention may contain other additives, in addition to the above-described components. Examples of other additives include known additives such as discolorization inhibitors, emulsion stabilizers, permeation accelerators, UV absorbers, preservatives, mold-inhibiting agents, pH adjusters, defoaming agents, viscosity adjusters, dispersants, dispersion stabilizers, rust inhibitors and chelating agents. These various additives may be directly added after or during the preparation of aqueous ink composition.

A neutralizing agent (such as organic bases or inorganic alkali) may be used as the pH adjuster. From the viewpoints of improving storage stability of the aqueous ink composition, the pH adjuster is preferably added so that pH of the aqueous ink composition becomes to the range of from 6 to 10, and more preferably from 7 to 10. The pH is measured at 25° C.

From the viewpoints of ejection stability in the time of ejection using an ink jet method and aggregation speed of ink achieved by using the fixing agent liquid, the viscosity of the ink of the present invention composition is preferably from 1 mPa·s to 30 mPa·s, more preferably from 1 mPa·s to 20 mPa·s, still more preferably from 2 mPa·s to 15 mPa·s, and still more preferably from 2 mPa·s to 10 mPa·s.

In addition, the viscosity is measured under conditions of 20° C. using VISCOMETER TV-22 (trade name, manufactured by Toki Sangyo Co., Ltd).

From the viewpoints of dispersion stability of ink, and low corrosion to members constituting an ink jet recording apparatus, ejection stability in the time of ejection using an ink jet method and aggregation speed of ink achieved by using the fixing agent liquid, the pH of the ink used in the present invention composition is preferably from 6 to 10, and from the viewpoint of long-period dispersion stability of ink, the pH is preferably from 7 to 10, more preferably from 7.5 to 10, and still more preferably from 7.5 to 9.5. The pH is measured at 25° C.

Method for Forming Image

The image-forming method of the present invention uses the ink set for ink jet of the present invention and includes a fixing agent liquid-applying process that applies a fixing agent liquid to a recording medium and an ink-applying process that applies the ink to the recording medium using an ink jet method to record an image thereon.

Based on this configuration, rub resistance of images can be improved and a high-quality-imageiformation can be achieved.

The image-forming method of the present invention may further include other processes, if needed. Examples of the other processes include a hot-fixing process in which the ink image formed by ink application is fixed to the recording medium by heating.

Fixing Agent Liquid Applying Process

A process for applying the fixing agent liquid used in the present invention is carried out by applying the fixing agent liquid to a recording medium. The details of the composition and preferred embodiments of the fixing agent liquid are described above.

The application of fixing agent liquid may be carried out using a known method such as a coating method, an ink jet method and an immersion method. For example, the coating may be carried out by a known coating method using a bar coater, an extrusion die coater, an air doctor coater, a blade coater, a rod coater, a knife coater, a squeeze coater, a reverse roll coater or the like. The details of ink jet method are described in the following ink application process.

The application of fixing agent liquid may be performed before or after the following ink applying process. In a preferred embodiment of the present invention, the ink applying process is performed after the fixing agent liquid applying process. That is, in the preferred embodiment, before application of the ink to the recording medium, the fixing agent liquid to aggregate the color material (preferably, pigment) in the ink is preliminarily applied to the recording medium and then the ink is applied to the recording medium such that the ink comes in contact with the fixing agent liquid, thereby forming an image. As a result, image formation can be realized at a high speed and images with high density and high resolution can be obtained even at a high speed.

The application amount of the fixing agent liquid is not particularly limited so long as it enables aggregation of the ink and is preferably controlled to the amount so that the application amount of aggregating component becomes 0.1 g/m² or higher. Of these, the application amount of the fixing agent liquid is preferably an amount so that the application amount of aggregating component becomes from 0.1 g/m² to 1.0 g/m², and more preferably from 0.2 g/m² to 0.8 g/m². When the application amount of the aggregating component is 0.1 g/m² or more, the aggregation reaction favorably makes progress and when the application amount is 1.0 g/m² or less, excess glossiness can be favorably prevented.

In addition to the fixing agent liquid applying process and the ink applying process that are performed thereafter, the method of the present invention preferably includes a hot-drying process for hot-drying the fixing agent liquid on a recording medium in the period of time that is after the fixing agent liquid has been applied to the recording medium, but until the ink is applied to the recording medium. Preliminary hot-drying of the fixing agent liquid before the ink is applying process enables improvement of ink coloring properties such as suppression of bleeding. Resultantly, visible images having a favorable color density and color phase can be recorded.

The hot-drying may be carried out using a known heating apparatus such as a heater, an air blaster using blast air such as dryer, or a combination thereof. Examples of the heating include applying heat from the opposite to the surface of the recording medium to which the fixing agent liquid is applied; applying warm or hot air to the surface of the recording medium to which the fixing agent liquid is applied; heating using an infrared heater and a combination thereof.

Ink Applying Process

The ink applying process used in the present invention is carried out by applying the ink on a recording medium by inkjetting to record an image. The composition and preferred embodiments of the ink used for the process are described above.

In addition, the ink jetting is not particularly limited and may be any known type such as a charge control method in which an ink is ejected using electrostatic attractive force, a piezo inkjetting for jetting an ink using a piezoelectric device to generate mechanical strain via application of voltage, an acoustic ink jet method in which an electric signal is converted to an acoustic beam, the beam is irradiated to an ink and acoustic radiation pressure is used to eject the ink, and a thermal ink jet (BUBBLE JET: trade name) method in which an ink is heated to form bubbles, and the resulting pressure is utilized to eject the ink.

The ink jetting methods include a method in which a low concentration of ink referred to as “photoink” is ejected in plural small volumes, a method in which plural inks with substantially the same color and different concentration are used to improve image quality, and a method in which a colorless transparent ink is used.

Preferred is the piezo inkjetting as the ink jetting method used in the present invention. By combining the ink set for an ink jet of the present invention and the piezo ink jetting, continuous ejectability and ejection stability of the ink can be further improved.

In the piezo ink jetting, the distortion type of the piezoelectric device may be a warp mode, a longitudinal mode, or a shear mode. The configuration of piezoelectric device and structure of the piezo head are selected from known techniques without particular limitation.

The ink nozzles used for recording using an ink jetting method may be selected appropriately depending on purposes without particular limitation.

In addition, the ink jetting method may be a shuttle method in which recording is performed by scanning a head in a width direction of the recording medium using a short serial head or a line method using a line head in which a recording device is arranged over the entire surface of one side of the recording medium. In accordance with the line method, the recording medium is scanned in a direction perpendicular to the arrangement direction of the recording device to record images over the entire surface of the recording medium. In addition, only the recording medium is transferred, thereby realizing high recording rate, as compared to the shuttle method.

The amount of liquid droplets of ink ejected from the ink jet head is preferably from 0.2 pl to 10 pl (picoliter), and more preferably from 0.4 pl to 5 pl.

In addition, during image recording, the maximum total ejection amount of ink is preferably from 10 ml/m² to 36 ml/m², and more preferably from 15 ml/m² to 30 ml/m².

In addition, the method of the present invention preferably further includes hot-drying the ink on the recording medium after ink applying process. By hot-drying the ink after the ink applying process, the aggregation speed of ink can be increased. The hot-drying can be carried out in the same manner as the hot-drying of the fixing agent liquid described above.

Hot-Fixing Process

In a hot-fixing process, images recorded by ink application are fixed on the recording medium by heating. The hot-fixing enables the images to be fixed on the recording medium and further improvement of rub resistance of the images. Accordingly, preferably, the image-forming method of the present invention includes the hot-fixing process.

Preferably, the heating is carried out at a minimum film forming temperature (MFT) or higher of the first anionic polymer in the image. When the heating is performed at the MFT or higher, polymer particles form a thin film which results in the image being reinforced.

The pressure applied during pressing with heating is preferably within the range of from 0.1 MPa to 3.0 MPa, more preferably from 0.1 MPa to 1.0 MPa, and still more preferably from 0.1 MPa to 0.5 MPa in terms of surface smoothing.

The heating method is not particularly limited and examples thereof include non-contact type drying methods such as heating with a heat-generator such as a nichrome wire heater, supplying warm air or hot air, and heating with an apparatus such as a halogen lamp or an infrared lamp. In addition, the method for hot-pressing is not particularly limited and suitable examples thereof include contact-type heating pressing such as pressing a hot plate on the image-forming side of a recording medium and passing through a pair of rollers using a hot-pressing apparatus provided with a pair of hot-pressing rollers, a pair of hot-pressing belts, or a retaining roller arranged on the image-recording side of the recording medium and a hot-pressing belt arranged opposite thereto.

In the case of hot-pressing, a nip period is preferably from 1 millisecond to 10 seconds, more preferably from 2 milliseconds to 1 second, and still more preferably from 4 milliseconds to 100 milliseconds. In addition, a nip width is preferably from 0.1 mm to 100 mm, more preferably from 0.5 mm to 50 mm, and still more preferably from 1 mm to 10 mm.

The hot-pressing roller may be a metal roller made of a metal material, or may be provided with a coating layer made of an elastic body around a cored bar made of a metal material and optionally a surface layer (also referred to as a release layer). The cored bar may take the form of a cylindrical body made of an iron material, an aluminum material or a SUS material and the surface of the cored bar is preferably at least partially coated with the coating layer. The coating layer is particularly preferably made of a silicone or fluorine resin with a release property. In addition, a heat-generating body is preferably mounted in the cored bar arranged at the one side of the hot-pressing roller. The recording medium is passed through a pair of rollers and thus is simultaneously heated and pressed, or the recording medium may be optionally heated by packing it in between two heating rollers. The heat-generating body is preferably, for example, a halogen lamp heater, a ceramic heater, a nichrome wire or the like.

The belt base material constituting the hot-pressing belt used for the hot-pressing apparatus is preferably seamless nickel-plated brass and the thickness thereof is preferably from 10 μm to 100 μm. In addition, the belt base material may use aluminum, iron, polyethylene or the like, in addition to nickel. In the case where a silicone resin or a fluorine resin is prepared, the thickness of layer formed using the resin is preferably from 1 μm to 50 μm, and more preferably from 10 μm to 30 μm.

In addition, in order to realize the pressure (nip pressure), for example, an elastic member such as a spring having a tension may be selected and mounted on both ends of roller such as a hot-pressing roller, to obtain the desired nip pressure, when taking into consideration the nip gap.

In the case where a hot-pressing roller or a hot-pressing belt is used, the conveying speed of the recording medium is preferably within the range from 200 mm/sec to 700 mm/sec, more preferably from 300 mm/sec to 650 mm/sec, and still more preferably from 400 mm/sec to 600 mm/sec.

Recording Medium

The image-forming method of the present invention is to form an image on a recording medium. Any recording medium may be used without particular limitation and the medium may be a coated paper for general offset printing or the like or an exclusive paper for ink jet.

A coated paper includes a coat layer provided by coating a coat material on the surface of a high-quality paper or a neutralized paper which is made of cellulose as a main component and is generally not surface-treated. The coated paper is commercially available. Specific examples of the coated paper include “OK PRINCE HIGH QUALITY” (trade name, manufactured by Oji Paper Co., Ltd.), “SIRAOI” (trade name, manufactured by Nippon Paper Group, Inc.) and high-quality paper (A) such as “NEW NPI HIGH QUALITY” (trade name, manufactured by Nippon Paper Group, Inc.), “OK EVER LIGHT COAT” (trade name, manufactured by Oji Paper Co., Ltd.), fine coated paper such as “AURORA S” (trade name, manufactured by Nippon Paper Group, Inc.), “OK COAT L” (trade name, manufactured by Oji Paper Co., Ltd.), light-weight paper (A3) such as “AURORA L” (trade name, manufactured by Nippon Paper Group, Inc.), “OK TOPCOAT+” (trade name, manufactured by Oji Paper Co., Ltd.), and coat paper (A2, B2) such as “AURORA COAT” (trade name, manufactured by Nippon Paper Group, Inc.), and “OK KINFUJI+” (trade name, manufactured by Oji Paper Co., Ltd.) and art paper (A1) such as “TOKUBISHI ART PAPER” (manufactured by Mitsubishi Paper Mills Ltd.).

Hereinafter, aspects of the present invention are described and are not limited thereto.

<1> An ink set for ink jet containing a fixing agent liquid including an acidic precipitant and a cationic polymer that is a copolymer; and an ink including a self-dispersing pigment and a first anionic polymer in an aqueous medium wherein the first anionic polymer is insoluble in the aqueous medium.

<2> The ink set for ink jet described in <1>, wherein the aqueous medium is an aqueous medium including a hydrophilic organic solvent.

<3> The ink set for ink jet described in <1> or <2>, wherein the acidic precipitant is at least one of methanesulfonic acid, citric acid, succinic acid, phosphoric acid, glycolic acid, acetic acid, tartaric acid, oxalic acid, or derivatives or salts thereof.

<4> The ink set for ink jet described in any one of <1> to <3>, wherein the fixing agent liquid includes at least one selected from the group consisting of polyvalent metal nitrates, EDTA salts, phosphonic acid-based chelating agents and salts thereof.

<5> The ink set for ink jet described in any one of <1> to <4>, wherein the first anionic polymer is a self-dispersing polymer particle.

<6> The ink set for ink jet described in any one of <1> to <5>, wherein the self-dispersing pigment is a pigment having a covalently bonded second anionic polymer.

<7> The ink set for ink jet described in any one of <1> to <6>, wherein the pigment contained in the self-dispersing pigment is carbon black.

<8> The ink set for ink jet described in any one of <1> to <7>, wherein the ink further includes a nonionic surfactant.

<9> A method for forming an image using the ink set for ink jet described in any one of <1> to <8>, the method including: applying the fixing agent liquid to a recording medium and applying the ink to the recording medium by inkjetting.

<10> The method described in <9> wherein the inkjetting is a piezo inkjetting.

<11> The method described in <9> or <10>, further including: fixing the image formed by the applying of the ink to the recording medium by heating.

The present invention makes it possible to provide an ink set for ink jet which exhibits superior continuous ejection and ejection stability and improves abrasion resistance, and an image-forming method capable of forming images having improved rub resistance of images and good qualities.

### Examples

Hereinbelow, the invention will be described in detail by way of Examples. However, the invention is not limited to these Examples as long as the scope of the invention is not impaired. In the description of examples, unless otherwise specified, “parts” refers to parts by mass, and “%” means % by mass.

The weight average molecular weight is measured with a gel permeation chromatography (GPC). As a GPC instrument, HLC-8220GPC manufactured by Tosoh Corporation, is used; there columns of TSKgel Super Multipore HZ-H (manufactured by Tosoh Corporation, 4.6 mmID×15 cm) are used and connected in tandem; and THF (tetrahydrofuran) is used as an eluent. Further measurement conditions are set as follows.

Sample concentration: 0.35% by mass
Flow rate: 0.35 ml/min
Injected amount of sample: 10 μl
Measuring temperature: 40° C.
Measurement is conducted using an I R detector.
The calibration curve is prepared from 8 samples of “Standard sample TSK standard, polystyrene”: “F-40”, “F-20”, “F-4”, “F-1”, “A-5000”, “A-2500”, “A-1000” and “n-PROPYL BENZENE” (all trade names, manufactured Tosoh Corporation).

Preparation of First Anionic Polymer Preparation of Polymer Dispersion C

360.0 g of methyl ethyl ketone was placed in a 2 L three necked flask equipped with a stirrer, a thermometer, a reflux condenser tube, and a nitrogen gas introducing pipe, and the temperature was raised to 75° C. Thereafter, while maintaining the temperature inside the flask at 75° C., a mixed solution containing 180.0 g of phenoxyethyl acrylate, 162.0 g of methyl methacrylate, 18.0 g of acrylic acid, 72 g of methyl ethyl ketone, and 1.44 g of V-601 (trade name, manufactured by Wako Pure Chemical Industries, Ltd.) was added dropwise thereto at a constant rate so that the dropwise addition was completed in 2 hours. After completion of the dropping, a solution containing 0.72 g of V-601 and 36.0 g of methyl ethyl ketone was added thereto, and stirred at 75° C. for 2 hours. Further, a solution containing 0.72 g of V-601 and 36.0 g of isopropanol was added thereto, and stirred at 75° C. for 2 hours. Thereafter, the temperature was raised to 85° C., and the stirring was continued for further 2 hours, thereby obtaining a resin solution of a phenoxy ethyl acrylate/methyl methacrylate/acrylic acid (=50/45/5 [mass ratio]) copolymer.

The weight average molecular weight (Mw) of the obtained copolymer was 64,000 (determined by gel permeation chromatography (GPC) and polystyrene conversion), the acid value thereof was 38.9 (mgKOH/g).

To 668.3 g of the thus-obtain resin solution d, 388.3 g of isopropanol and 145.7 ml of a 1 mol/L NaOH aqueous solution were added and, the temperature inside the reaction vessel was heated to 80° C. Then, 720.1 g of distilled water was added dropwise thereto at the rate of 20 ml/min to make an aqueous dispersion. After that, the aqueous dispersion was maintained under atmospheric pressure at the temperature inside the reaction vessel of 80° C. for 2 hours, at 85° C. for 2 hours and at 90° C. for 2 hours, and then the pressure of the reaction vessel was reduced, and 913.7 g of isopropanol, methyl ethyl ketone and distilled water in terms of a total amount was removed by distillation, thereby obtaining an aqueous dispersion of an anionic polymer (polymer dispersion C) having a solid content of 28.0% by mass.

Preparation of Polymer Dispersion D

100.5 g of methyl methacrylate, 117.5 g of hexyl acrylate, 24 g of mono methacryloyloxyethyl succinate, 2.3 g of ethylene glycol dimethacrylate, and 1.0 g of isooctyl thioglycolate were mixed to a prepare a monomer mixture. Subsequently, 85 g of water and 20.8 g of 30% Rhodafac (trademark) were added to the monomer mixture and carefully stirred like a shearing to prepare an emulsion. At the same time, 0.87 g of potassium persulfate was dissolved in 100 g of water to prepare an initiator solution. The initiator solution was added dropwise to 725 g of water heated to 90° C. in a reactor. This dropwise addition is carried out while stirring water. While adding the initiator solution, the emulsion was added dropwise to water. The resulting reaction mixture was stirred at 90° C. for 2 hours and then cooled. When the temperature of the reaction vessel was dropped to about 50° C., 23 g of a 17.5% potassium hydroxide solution was added to the reaction mixture to adjust pH of the reaction mixture to 8.5. The reaction mixture was filtered using a 200 mesh filter to obtain an aqueous dispersion of an anionic polymer (polymer dispersion D).

Evaluation of Solubility of Anionic Polymer with Respect to Aqueous Medium

Respective components were mixed in accordance with the composition ratio shown in Table 1 to obtain mixed solutions A to C of an aqueous medium composed of water and a water-soluble organic solvent, and an anionic polymer.

JONCRYL 586 (Registered trademark, manufactured by BASF Japan Ltd.) shown in Table 1 is a styrene-acrylic acid copolymer.

For the mixed solutions A to C, solubility of the anionic polymer with respect to an aqueous medium was evaluated in the following manner. The term “dissolution” refers to a state in which a mixed liquid is a transparent solution under conditions of a liquid temperature of 25° C. and neither suspension nor precipitation is confirmed in the mixed liquid. In the case where the mixed liquid is not a transparent solution and suspension is confirmed, ultrafiltration was performed using an ultrafiltration membrane with a fraction molecular weight of 10000. Thereafter, a visually transparent filterate was dried and the dried material was weighted and the weight was defined as amount of dissolution of the anionic polymer.

The results thus obtained are shown in Table 1.

TABLE 1

| | Mixed | Mixed | Mixed |
|---|---|---|---|
| | solution | solution | solution |
| | A | B | C |
| Tripropylene glycol | 9.4 | 9.4 | 9.4 |
| Triethylene glycol | 7.3 | 7.3 | 7.3 |
| monomethyl ether | | | |
| 2-hydroxyethyl-2- | 4.2 | 4.2 | 4.2 |
| pyrrolidone | | | |
| Polymer dispersion C | 8 * | — | — |
| Polymer dispersion D | — | 8 * | — |
| JONCRYL586 | — | — | 8 * |
| Sodium hydroxide | Amount added | Amount added | Amount added |
| | to adjust | to adjust | to adjust |
| | pH to 8.5 | pH to 8.5 | pH to 8.5 |
| Ion exchange water | Remainder | Remainder | Remainder |
| Visual evaluation | Suspended | Suspended | Dissolved |
| Dissolved amount of | Below | 21.2% | — |
| anionic polymer (ratio | measurable | | |
| to the total mass of | limit | | |
| the solid of mixture) | | | |

The composition ratio is based on % by mass and * is a reduced quantity based on the solid.

It is seen from the results of Table 1 that JONCRYL 586 is dissolved in the aqueous medium that constitutes the mixed liquids A to C, and the polymer dispersion D is partially dissolved in the aqueous medium. Meanwhile, it is seen that the polymer dispersion C is insoluble in the aqueous medium.

In addition, the composition of water and water-soluble organic solvent is common to the aqueous medium that constitutes the mixed liquids A to C and the aqueous medium that constitutes the inks A to E described below. In addition, the pH of each of these aqueous media is nearly identical.

Accordingly, it is seen that JONCRYL 586, the polymer dispersion C and the polymer dispersion D exhibit the same solubility as the results shown in Table 1, with respect to the aqueous medium that constitutes inks A to E.

Preparation of Pigment Having a Covalently Bonded Second Anionic Polymer

Preparation of Halogen Group-Modified Pigment

550 g (reduced quantity based on the solid) of carbon black (BLACK PEARLS 700 (trade name), manufactured by Cabot corporation) and 150.8 g of p-amino benzoic acid were mixed with 1000 g of deionized water, heated to 50° C. and stirred for 15 minutes. A solution of 68 g of NaNO₂ dissolved in 200 mL of water was added thereto, heated to 60° C. and stirred for 3 hours. Subsequently, the reaction mixture was diluted with water to remove a precipitate until the concentration of carbon black became about 15% (reduced quantity based on the solid) and was purified by centrifugation and membrane separation to obtain carbon black dispersion.

Hydrochloric acid was added to 15 g of the dispersion to acidize the dispersion to pH 2 thereby precipitating carbon black. The resulting product was filtered, washed with water, centrifuged and vacuum-dried to obtain a carbon black dry powder.

The dry powder thus obtained was homogenized in 250 mL of dry THF using a rotor stator mixer. 18 g of dicyclohexylcarbodiimide (DCC), 2.6 g of N,N-dimethylaminopyridine (DMAP), and 19.4 g of 2,2-dimethyl-3-hydroxypropyl α-bromoisobutylate were added thereto. The components were mixed while stirring for 5 hours and reacted overnight while stirring with a magnetic stirring bar. Subsequently, the reaction solution was centrifuged several times in THF to obtain a modified carbon black containing a halogen group (halogen group-modified carbon black).

Preparation of Polymer-Modified Pigment

1.20 g of the halogen group-modified carbon black thus obtained, CuBr₂ (0.5 mL of crude solution in anisole, 0.0143 mmol), 100 mL (0.476 mmol) of pentamethyl dodecan triamine, 11.3 g (0.088 mol) of n-butyl acylate (n-BA) and 8 mL of anisole were placed to a Schlenk flask and degassed using 3 freeze-pump-thaw cycles. Separately, CuBr (97%, manufactured by Aldrich Chemical Company) was stirred in glacial acetic acid, the resulting product was filtered, and then the formed solid was washed with ethanol three times and diethylether twice and vacuum-dried. The degassed material was frozen. Under a nitrogen atmosphere, 0.068 g of CuBr thus obtained was placed to the flask. The resulting mixture was polymerized at 70° C. for 13 hours and converted into 7% n-butyl acrylate. Subsequently the resulting product was purified by centrigufation to obtain poly(n-BA)-modified carbon black (polymer-modified pigment having a covalently bonded poly(n-BA)).

0.76 g of poly(n-BA)-modified carbon black thus obtained was vacuum-dried for 12 hours, and then dry carbon black was dispersed in 4 mL of anisole by an ultrasonic wave treatment at a low temperature for 30 minutes. 5.65 g (0.044 mmol) of t-butyl acylate (t-BA) and CuBr₂ (0.25 mL of crude solution in anisole, 0.00714 mmol) were added thereto and then an ultrasonic wave treatment was conducted at a low temperature under a nitrogen atmosphere. 50 mL (0.238 mmol) of pentamethyl dodecan triamine was added thereto, the dispersion was degassed using freeze-pump-thaw cycles, and then 0.034 g (0.238 mmol) of CuBr was added thereto under nitrogen, and then polymerized at 70° C. for 60 hours, and then purified by centrifugation. Subsequently, for dealkylization 0.5 g of the purified substance was stood overnight in a solution of 1.2 g of trifluoro acetic acid dissolved in 20 mL of THF.

As a result of this process, a polymer-modified carbon black to which polyacrylic acid polymer is covalently bonded was obtained.

Preparation of Pigment Dispersion A

The polymer-modified carbon black thus obtained was mixed with ion exchange water in accordance with the following composition and dispersed in a bead mill with a 0.1 mmφ zirconia bead for 3.5 hours. Subsequently, the dispersion was filtered, and water was added thereto such that the concentration of carbon black was 10.0% by mass to prepare polymer-modified carbon black dispersion (pigment dispersion A).

Composition of Pigment Dispersion A
Polymer-modified carbon black—15.0 parts
Ion exchange water—85.0 parts

Preparation of Polymer Dispersant-Coated Pigment

Synthesis of Resin Dispersant P-1

90 g of methyl ethyl ketone was placed in a 1000-ml three-necked flask equipped with a stirrer and a cooling tube, and then heated to 70° C. under a nitrogen atmosphere. A solution prepared by dissolving 0.83 g of dimethyl-2,2′-azobisisobutylate, 70 g of phenoxyethyl methacrylate, 10 g of methacrylic acid, and 20 g of methyl methacrylate in 52 g of methyl ethyl ketone was added dropwise to the flask over a period of 3 hours. After completion of the addition, the reaction was further continued for one hour, and then a solution prepared by dissolving 0.44 g of dimethyl-2,2′-azobisisobutylate in 2 g of methyl ethyl ketone was added thereto, and the mixture was heated at 80° C. for 5 hours. The reaction solution thus obtained was reprecipitated twice in excess amounts of hexane, and the precipitated resin was dried to obtain 93.2 g of a phenoxyethyl methacrylate/methyl methacrylate/methacrylic acid (copolymerization ratio [mass ratio]=70/20/10) copolymer (resin dispersant P-1).

The formulation of the obtained resin dispersant P-1 was identified with H-NMR. The weight average molecular weight (Mw) was determined by a GPC method, and was found to be 44,600. Furthermore, the acid value of the polymer was obtained in accordance with the method described in JIS Standard (JIS-K0070 (1992) and was found to be 66.2 mgKOH/g.

Preparation of Pigment Dispersion B

In a first dispersion process, respective components were mixed in accordance with the following composition and dispersed a bead mill with a 0.1 mmφ zirconia bead for 2 hours. Subsequently, in a second dispersion process, the following composition containing the resin dispersant P-1 was added thereto and dispersed for 2 hours, the methyl ethyl ketone was removed under reduced pressure at 55° C. from the resulting dispersant, some water was removed such that the concentration of carbon black was 10.0% by mass thereby preparing a dispersion of polymer-dispersible pigment (pigment dispersion B) (removal process).

Composition of First Dispersion Process
Carbon black—10.0 parts (#2600, manufactured by Mitsubishi Chemical Corporation), primary particle diameter: 13 nm, pH 6.5)
Resin dispersant P-1—3.7 parts
Methyl ethyl ketone—20.0 parts
1 normal NaOH aqueous solution—6.8 parts
Ion exchange water—55.7 parts

Composition of a Composition that is Added in Second Dispersion Process
Resin dispersant P-1—1.0 part
Methyl ethyl ketone—2.6 parts

Preparation of Ink

An ink composition was prepared in accordance with the composition ratios shown in Table 2 and filtered using a 0.2 μm membrane filter to obtain inks A to E.

The CAB-O-JET300 (trade name, manufactured by Cabot Corporation.) shown in Table 2 is a self-dispersing carbon black in which a carboxy group (—COOH) is present on the surface of pigment. Orfin E1010 (trade name, manufactured by Nissin Chemical Industry, Co., Ltd.) is an acetylene glycol surfactant and PROXEL XL2 is a preservative (manufactured by ICI Co., Ltd.)

TABLE 2

| | Ink A | Ink B | Ink C | Ink D | Ink E |
|---|---|---|---|---|---|
| Pigment dispersion A | 4 * | — | — | 4 * | 4 * |
| Pigment dispersion B | — | 4 * | — | — | — |
| CAB-O-JET300 | — | — | 4 * | — | — |
| Tripropylene glycol | 9 | 9 | 9 | 9 | 9 |
| Triethylene glycol | 7 | 7 | 7 | 7 | 7 |
| monomethyl ether | | | | | |
| 2-hydroxyethyl-2-pyrrolidone | 4 | 4 | 4 | 4 | 4 |
| Phosphate ester surfactant | 0.25 | 0.25 | 0.25 | 0.25 | 0.25 |
| Nonionic fluorine surfactant | 0.25 | 0.25 | 0.25 | 0.25 | 0.25 |
| ORFIN E1010 | 0.5 | 0.5 | 0.5 | 0.5 | 0.5 |
| Polymer dispersion C | 8 * | 8 * | 8 * | — | — |
| Polymer dispersion D | — | — | — | 8 * | — |
| JONCRYL 586 | — | — | — | — | 8 * |
| PROXEL XL2 | 0.3 | 0.3 | 0.3 | 0.3 | 0.3 |
| Ion exchange water | Remainder | Remainder | Remainder | Remainder | Remainder |
| ink pH | 8.3 | 8.5 | 8.4 | 8.5 | 8.5 |

The composition ratio is based on % by mass and * is a reduced quantity based on the solid.

### <Preparation of Fixing Agent Liquid>

Respective components were mixed in accordance with the composition ratios shown in Table 3 to obtain fixing agent liquids T-1 to T-9.

Floquat FL-14 (Registered trademark, manufactured by SNF Floerger, Inc.) was used as the copolymer of epihalohydrin and dimethylamine.

TABLE 3

| | T-1 | T-2 | T-3 | T-4 | T-5 | T-6 | T-7 | T-8 | T-9 |
|---|---|---|---|---|---|---|---|---|---|
| 4-methylmorpholine-n-oxide | 20 | 20 | 20 | 20 | 20 | 20 | 20 | 20 | 20 |
| Ethylhydroxy propanediol | 8 | 8 | 8 | 8 | 8 | 8 | 8 | 8 | 8 |
| Nonionic fluorine surfactant | 0.1 | 0.1 | 0.1 | 0.1 | 0.1 | 0.1 | 0.1 | 0.1 | 0.1 |
| ORFINE1010 | 0.9 | 0.9 | 0.9 | 0.9 | 0.9 | 0.9 | 0.9 | 0.9 | 0.9 |
| Epihalohydrin-dimethylamino | 2 | 2 | — | — | 2 | 2 | 2 | 2 | 2 |
| copolymer | | | | | | | | | |
| Poly(hexamethylene guanidine) | — | — | 2 | — | — | — | — | — | — |
| Poly(diallyldimethylammonium | — | — | — | 2 | — | — | — | — | — |
| chloride) | | | | | | | | | |
| Methanesulfonic acid | Amount | — | Amount | Amount | — | — | — | — | — |
| | added to | | added to | added to | | | | | |
| | adjust | | adjust | adjust pH to | | | | | |
| | pH to | | pH to | 3.5 | | | | | |
| | 3.5 | | 3.5 | | | | | | |
| Phosphoric acid | — | — | — | — | Amount | — | Amount | Amount | Amount |
| | | | | | added to | | added to | added to | added to |
| | | | | | adjust | | adjust | adjust | adjust |
| | | | | | pH to | | pH to | pH to | pH to |
| | | | | | 3.5 | | 3.5 | 3.5 | 3.5 |
| Tartaric acid | — | — | — | — | — | Amount | — | — | — |
| | | | | | | added to | | | |
| | | | | | | adjust pH to | | | |
| | | | | | | 3.5 | | | |
| Na₂EDTA | — | 0.1 | — | — | — | — | 0.1 | — | — |
| Magnesium nitrate•hexahydrate | — | — | — | — | — | — | — | 0.1 | — |
| Aminotri(methylenephosphonic acid) | — | — | — | — | — | — | — | — | 0.1 |
| Deionized water | Remainder | Remainder | Remainder | Remainder | Remainder | Remainder | Remainder | Remainder | Remainder |

The composition ratio is based on % by mass.

Image Formation

A GELJET GX5000 printer head (manufactured by RICOH Company, Ltd., full line head, piezoelectric type ink ejection) was prepared and inks A to E were placed in storage tanks connected thereto. A double-sided TOKUBISHI art paper N (water absorption coefficient Ka=0.21 mL/m²·ms^{1/2}, manufactured by Mitsubishi Paper Mills Ltd.) was prepared as a recording medium.

A double-sided TOKUBISHI art paper N was fixed on a transferable stage in a predetermined linear direction (vertical scanning direction during recording) at a rate of 500 mm/sec, the fixing agent liquids T-1 to T-9 were each coated so as to become a thickness of about 10 μm (equivalent to cationic copolymer amount: about 0.4 g/m²) using a wire bar coater and immediately thereafter dried at 50° C. for 2 seconds.

Then, the GELJET GX5000 printer head was set in a fixed arrangement such that a line head direction (main scanning direction) in which nozzles are arranged forms an angle of 75.7 degrees with a direction coplanarly perpendicular to a transfer direction (vertical scanning direction) of the stage, the recording medium was transferred in the vertical scanning direction at a constant rate and, at the same time, an ink was ejected linearly under ejection conditions of an ink liquid droplet amount of 2.8 pL, ejection frequency of 24 kHz, resolution of 1200 dpi×1200 dpi and a stage rate of 50 mm/sec, to record an image.

Immediately after the recording, the ink was dried at 60° C. for 3 seconds and fixed to a nip width of 4 mm at a nip pressure of 0.25 MPa through a pair of fixing rollers heated at 60° C. In addition, the fixing roller included a heating roll in which the surface of a cylindrical core bar (made of SUS), within which a halogen lamp is provided, is coated with a silicone resin, and an opposite roll pressing against the heating roller.

Evaluation

A test sample was prepared in the above-described image-forming method and was evaluated in the following manner. The results are shown in Table 4.

Continuous Ejectability

2,000 sheets of images, each having 10 wedge charts of 1 cm×10 cm placed at certain intervals were continuously formed under conditions of 23° C. and 20% RH. The 10^{th} and 2000^{th} images were compared by visual observation and evaluated in accordance with the following evaluation criteria. In addition, fixing was not performed in this evaluation.

Evaluation Criteria

3: Both the 10^{th} image and the 2000^{th} image exhibited neither print curve nor stripes (lines) (non-printing caused by non-ejection).

2: The 2000^{th} image exhibited print curve.

1: The 2000^{th} image exhibited both print curve and stripes or lines.

Recovery Property

10 sheets of images, each having 10 wedge charts of 1 cm×10 cm at certain intervals were continuously formed under conditions of 23° C. and 20% RH. After the formation of images was suspended for 30 minutes, 10 sheets of images were continuously formed. The 10 sheets of images after the suspension were visually observed for comparison and evaluated in accordance with the following evaluation criteria. In addition, fixing was not performed in this evaluation.

Evaluation Criteria

3: The 1^{st} image exhibited stripes or lines (non-printing caused by non-ejection from the nozzle), while the 10^{th} image exhibited a decrease in stripes and exhibited 2% (by number) or less of stripes or lines.

2: The 1^{st} image exhibited stripes or lines, while the 10^{th} image exhibited a decrease in stripes and exhibited from 2% (by number) to less than 10% (by number) of stripes or lines.

1: The 1^{st} image exhibited stripes or lines, and the 10^{th} image substantially exhibited no decrease in stripes and exhibited 10% (by number) or more of stripes.

Rub Resistance

In the image formation, the recording medium was replaced by OK TOPCOAT+(manufactured by Oji Paper Co., Ltd.) to form a 100% Duty solid image. Two recording media were placed on each other such that the image-forming surfaces of the respective media faced each other and the lower recording medium was rubbed 10 times with the upper recording medium at a load of 50 g.

For both recording media, scratching of the image area and staining of the non-image area adjacent to the image area were visually observed and evaluated with the following criteria.

Evaluation Criteria

5: Both recording media exhibited neither scratches in the two image areas nor stains in the non-image area.

4: Both recording media exhibited no scratches in the two image areas and slight stains in the non-image area.

3: At least one of the recording media exhibited slightly rubbed traces in the image area and slight stains in the non-image area.

2: At least one of the recording media exhibited slightly rubbed traces in the image area and stains in the non-image area.

1: Both the recording media exhibited scratches in the image area and stains in the non-image area.

Color Density

In the image formation, the recording medium was replaced by OK TOPCOAT+ (trade name, manufactured by Oji Paper Co., Ltd.) to form 100% Duty beta images. Optical density (OD) was measured using GRETAG MACBETH SPECTROSCAN SPM-50 (trade name, manufactured by Gretag Co., Ltd. (US)) and evaluated with the following criteria.

Evaluation Criteria

3: Optical density of 1.8 or more.

2: Optical density of from not less than 1.75 to less than 1.8.

1: Optical density of less than 1.75.

Spotting Interference

In the image formation, the stage rate was changed to 100 mm/sec, 250 mm/sec, 350 mm/sec and 500 mm/sec, and the ejection frequency was changed such that the spotting amount of the droplets became identical to form a solid image. Bleeding caused due to droplet interference between ink liquid droplets and mixing between colors (spotting interference) was observed with the naked eye and high-speed aggregability was evaluated at the highest stage speed exhibiting no spotting interference.

Evaluation Criteria

4: Spotting interference is not observed at 500 mm/sec.

3: Spotting interference is not observed at 350 mm/sec

2: Spotting interference is not observed at 250 mm/sec.

1: Spotting interference is not observed at 100 mm/sec.

Glossiness of Gloss Paper

In the image formation, the recording medium was charged to PM photo paper (manufactured by Seiko Epson Corporation). 100% Duty solid images were formed under conditions of 23° C. and 20% RH. The mirror glossiness of the image-formation surface at an incident angle of 60 degrees was measured using a glass checker IG-320 (trade name, manufactured by Horiba, Ltd.) and an average of five values measured was evaluated with the following criteria.

Evaluation Criteria

3: Average of 80 or higher.

2: Average equal to or higher than 75 and lower than 80.

1: Average of less than 75.

TABLE 4

| | | Fixing | | | | | | | |
|---|---|---|---|---|---|---|---|---|---|
| Ink | | agent | Continuous | Recovery | Rub | Color | Spotting | Glossiness of | |
| set | Ink | liquid | ejectability | property | resistance | density | interference | gloss paper | Note |
| 1 | A | T-1 | 3 | 3 | 5 | 3 | 4 | 3 | Present invention |
| 2 | A | T-5 | 3 | 3 | 4 | 3 | 3 | 3 | Present invention |
| 3 | A | T-6 | 3 | 3 | 4 | 3 | 3 | 3 | Present invention |
| 4 | A | T-2 | 3 | 3 | 1 | 1 | 1 | 1 | Comparative Example |
| 5 | A | T-3 | 3 | 3 | 1 | 1 | 2 | 1 | Comp. Ex. |
| 6 | A | T-4 | 3 | 3 | 1 | 1 | 1 | 1 | Comp. Ex. |
| 7 | B | T-1 | 2 | 2 | 2 | 1 | 2 | 1 | Comp. Ex. |
| 8 | C | T-1 | 2 | 3 | 3 | 3 | 3 | 3 | Present invention |
| 9 | C | T-5 | 2 | 3 | 4 | 3 | 3 | 3 | Present invention |
| 10 | D | T-1 | 2 | 1 | 1 | 2 | 2 | 2 | Comp. Ex. |
| 11 | E | T-1 | 1 | 1 | 1 | 1 | 1 | 1 | Comp. Ex. |
| 12 | A | T-7 | 3 | 3 | 5 | 3 | 4 | 3 | Present invention |
| 13 | A | T-8 | 3 | 3 | 5 | 3 | 4 | 3 | Present invention |
| 14 | A | T-9 | 3 | 3 | 5 | 3 | 3 | 3 | Present invention |

As is apparent from Table 4 above, the ink set for an inkjet of the present invention exhibited superior continuous ejection and recovery property, and favorable rub resistance of formed images. In addition, the ink set for an inkjet of the present invention exhibited favorable color density of formed images, efficient suppression of spotting interference and exhibited excellent glossiness at the time of image formation on a glossy paper.

In addition, for the ink sets 1, 2, 3, 8, 9, 12 to 14 which are ink sets of the present invention, 100% Duty solid images were formed by the image-forming method, and image areas were rubbed while moving back and forth 5 times with water-tissue paper and observed with naked eye. As a result, for all of the ink sets, images exhibited superior water resistance without image separation. In addition, the ink sets 1 and 8 exhibited slight decrease in glossiness of the robbed region.

All publications, patent applications, and technical standards mentioned in this specification were herein incorporated by reference to the same extent as if each individual publication, patent application, or technical standard was specifically and individually indicated to be incorporated by reference.

What is claimed is:

1. An ink set for ink jet comprising: a fixing agent liquid comprising an acidic precipitant and a cationic polymer that is a copolymer of epihalohydrin and amine; and an ink comprising a self-dispersing pigment and a first anionic polymer in an aqueous medium wherein the first anionic polymer is insoluble in the aqueous medium.

2. The ink set for ink jet according to claim 1, wherein the aqueous medium comprises a hydrophilic organic solvent.

3. The ink set for ink jet according to claim 1, wherein the acidic precipitant comprises at least one of methanesulfonic acid, citric acid, succinic acid, phosphoric acid, glycolic acid, acetic acid, tartaric acid, oxalic acid, or derivatives or salts thereof.

4. The ink set for ink jet according to claim 1, wherein the fixing agent liquid comprises at least one selected from the group consisting of polyvalent metal nitrates, EDTA salts, phosphonic acid-based chelating agents and salts thereof.

5. The ink set for ink jet according to claim 1, wherein the first anionic polymer comprises a self-dispersing polymer particle.

6. The ink set for ink jet according to claim 1, wherein the self-dispersing pigment comprises a pigment having a covalently bonded second anionic polymer.

7. The ink set for ink jet according to claim 1, wherein the self-dispersing pigment comprises carbon black.

8. The ink set for ink jet according to claim 1, wherein the ink further comprises a nonionic surfactant.

9. A method of forming an image using the ink set for ink jet according to claim 1, the method comprising: applying the fixing agent liquid to a recording medium and applying the ink to the recording medium by inkjetting.

10. The method according to claim 9, wherein the inkjetting comprises piezo inkjetting.

11. The method according to claim 9, further comprising: fixing the image formed by the applying of the ink to the recording medium by heating.
